(19) United States
(12) Patent Application Publication
(10) Pub. No.: US 2021/0360729 A1
(43) Pub. Date: Nov. 18, 2021

(54) DEVICES FOR PER-CC MEASUREMENT GAP CONFIGURATION

(71) Applicant: Apple Inc., Cupertion, CA (US)

(72) Inventors: Candy Yiu, Portland, OR (US); Yang Tang, San Jose, CA (US)

(21) Appl. No.: 16/479,856

(22) PCT Filed: Jan. 31, 2018
(86) PCT No.: PCT/US2018/016207

§ 371 Date: Jul. 22, 2019

Related U.S. Application Data
(60) Provisional application No. 62/453,978, filed on Feb. 2, 2017.

(51) Int. Cl. H04W 76/27; H04W 24/10; H04W 76/10

(52) U.S. Cl. CPC H04W 76/27; H04W 76/10; H04W 24/10

(57) ABSTRACT

Devices, methods, user equipment (UE), core network devices, base stations, and storage media are provided for per-component carrier (CC) and network controlled small gap (ncsg) measurement gap configuration. In one embodiment, processing circuitry of a UE decodes an RRCConnectionReconfiguration communication from a base station, the RRCConnectionReconfiguration communication comprising a measure gap configuration (MeasGapConfig) information element, the MeasGapConfig information element comprising a gap offset field (gapOffset) indicating one or more gap offset gap patterns, the one or more gap offset gap patterns (gp) comprising at least a first network-controlled small-gap (ncsg) gap pattern (gp-ncsg). Information from this communication is used to set up a measurement gap configuration indicated by the MeasGapConfig information element in accordance with the gapOffset. Other embodiments involve other information for various combinations of per-CC and ncsg gap configurations.

### PRIORITY CLAIM

This application claims the benefit of priority to U.S. Provisional Patent Application Ser. No. 62/453,978, filed Feb. 2, 2017, and titled “PER-COMPONENT CARRIER MEASUREMENT GAP AND NETWORK,” which is incorporated herein by reference in its entirety.

### TECHNICAL FIELD

Embodiments pertain to systems, methods, and component devices for wireless communications, and particularly to gap measurement handling in Third Generation Partnership Project (3GPP) communication systems.

### BACKGROUND

Long-term evolution (LTE) and LTE-Advanced are standards for wireless communication information (e.g., voice and other data) for user equipment (UE) such as mobile telephones. Such systems operate with UEs communicating with a network via cells of radio access technology (RAT) systems which may include an evolved node B (eNB) or other base station systems for providing an initial wireless connection to the larger system. As part of the communication between a UE and an eNB on one or more carriers, the system may manage measurement of peripheral carriers and cells other than the ones being used by the UE using measurement gaps.

### BRIEF DESCRIPTION OF THE FIGURES

In the figures, which are not necessarily drawn to scale, like numerals may describe similar components in different views. Like numerals having different letter suffixes may represent different instances of similar components. The figures illustrate generally, by way of example, but not by way of limitation, various embodiments discussed in the present document.

FIG. 1 is a diagram of a wireless network, in accordance with some embodiments.

FIG. 2 illustrates components of a wireless communication network, in accordance with some embodiments.

FIG. 3 illustrates operations and communications for per-component carrier measurement gap operations and network-controlled small-gap signaling, in accordance with some embodiments.

FIG. 4 illustrates operations and communications for per-component carrier measurement gap configurations, in accordance with some embodiments.

FIG. 5 illustrates operations and communications for per-component carrier measurement gap configurations, in accordance with some embodiments.

FIG. 6 illustrates an example method performed by a UE, in accordance with embodiments described herein.

FIG. 7 illustrates an example method performed by a network device, in accordance with embodiments described herein.

FIG. 8 illustrates an example method performed by a UE, in accordance with embodiments described herein.

FIG. 9 illustrates an example method performed by a network device, in accordance with embodiments described herein.

FIG. 10 illustrates an example UE, which may be configured for specialized operation or otherwise used with various embodiments described herein.

FIG. 11 is a block diagram illustrating an example computer system machine which may be used in association with various embodiments described herein.

FIG. 12 illustrates aspects of a UE, a wireless apparatus, or a device, in accordance with some example embodiments.

FIG. 13 illustrates example interfaces of baseband circuitry in accordance with some embodiments.

### DETAILED DESCRIPTION

The following description and the drawings sufficiently illustrate specific embodiments to enable those skilled in the art to practice them. Other embodiments may incorporate structural, logical, electrical, process, and other changes. Portions and features of some embodiments may be included in, or substituted for, those of other embodiments. Embodiments set forth in the claims encompass all available equivalents of those claims.

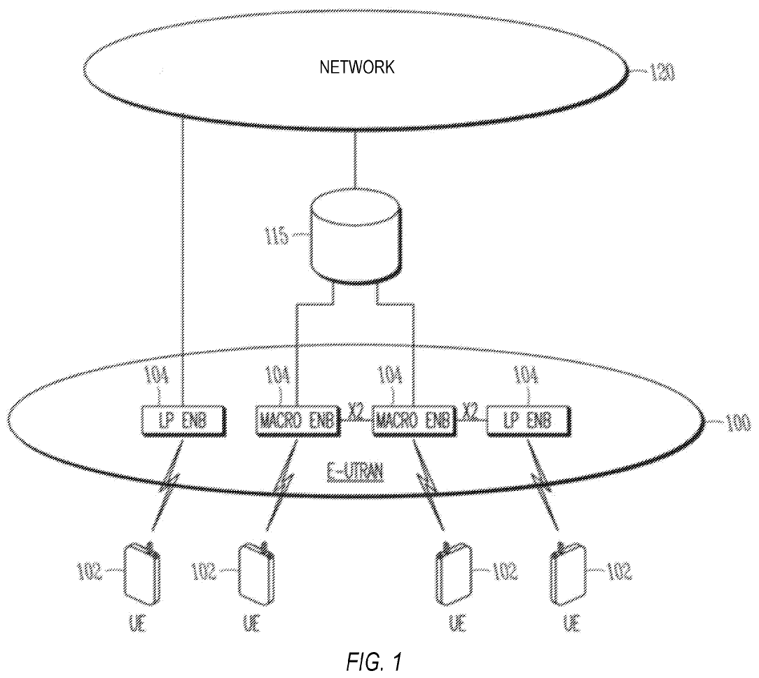

FIG. 1 shows an example of a portion of an end-to-end network architecture of a network (e.g., an LTE network, a 3GPP standardized network, a compatible NextGen system, etc.) with various components of the network, in accordance with some embodiments. Such a network architecture may be used to implement various communication system implementations, including systems that operate with configurable measurement gap settings for per-component carrier (CC) gap configurations or network-controlled small-gap (NCSG) operations. Such systems operate as part of complex carrier aggregation (CA) capabilities to allow a network to efficiently measure network conditions and enable communication operations under the measured conditions.

As used herein, “LTE network” refers to both LTE and LTE Advanced (LTE-A) networks, as well as other versions of LTE networks in development, such as 4G and 5G LTE networks, which are examples of NextGen networks. The network may comprise a radio access network (RAN) (e.g., as depicted, the Evolved Universal Terrestrial Radio Access Network (E-UTRAN)) 100 and a core network 120. For convenience and brevity, only a portion of the core network 120, as well as the RAN 100, is shown in the example.

The core network 120 may include various components, such as a mobility management entity (MME), a serving gateway (S-GW), and a packet data network gateway (PDN GW), in addition to other elements discussed below. Various core network systems may include different combinations of elements as described herein. The RAN 100 may include evolved node Bs (eNBs) 104 for communicating with user equipments (UEs) 102. The eNBs 104 may include macro eNBs and low-power (LP) eNBs. In various systems, the eNBs 104 may be considered base stations and the UEs 102 may be considered handsets, or any other such terminology may be used to refer to such devices in communication systems that operate in accordance with the embodiments described herein. The eNBs 104 may employ the techniques described herein to communicate information between the core network 120 and a UE 102 as described herein.

The eNBs 104 (macro and LP) may terminate the air interface protocol and may be the first point of contact for a UE 102. In some embodiments, an eNB 104 may fulfill various logical functions for the RAN 100 including, but not limited to, radio network controller (RNC) functions such as radio bearer management, uplink and downlink dynamic radio resource management and data packet scheduling, and mobility management. In accordance with some embodiments, the UEs 102 may be configured to communicate orthogonal frequency-division multiplexed (OFDM) communication signals with an eNB 104 over a multi-carrier communication channel in accordance with an orthogonal frequency-division multiple access (OFDMA) communication technique. The OFDM signals may comprise a plurality of orthogonal subcarriers.

An interface 115 may be the interface that separates the RAN 100 and the core network 120. It may be split into two parts in some embodiments: the S1-U, which may carry traffic data between the eNBs 104 and an S-GW of the core network 120; and the S1-MME, which may be a signaling interface between the eNBs 104 and an MME of the core network 120. An X2 interface may be the interface between pairs of the eNBs 104. The X2 interface may comprise two parts: the X2-C and X2-U. The X2-C may be the control-plane interface between the eNBs 104, while the X2-U may be the user-plane interface between the eNBs 104.

In cellular networks, the LP eNBs 104 in some embodiments are used to extend coverage to indoor areas where outdoor signals do not reach well, or to add network capacity in areas with dense usage. In particular, it may be desirable to enhance the coverage of a wireless communication system using cells of different sizes, such as macrocells, microcells, picocells, and femtocells, to boost system performance. The cells of different sizes may operate on the same frequency band, or may operate on different frequency bands with each cell operating on a different frequency band or only cells of different sizes operating on different frequency bands. As used herein, the term “LP eNB” refers to any suitable relatively LP eNB for implementing a smaller cell (smaller than a macrocell) such as a femtocell, a picocell, or a microcell. Femtocell eNBs are, in some embodiments, provided by a mobile network operator to its residential or enterprise customers. A femtocell, in some embodiments, is the size of a residential gateway or smaller and may generally connect to a broadband line. The femtocell may connect to the mobile operator's mobile network and provide extra coverage in a range of 30 to 50 meters. Similarly, a picocell may be a wireless communication system covering a small area, such as in-building (offices, shopping malls, train stations, etc.), or more recently, in-aircraft. A picocell eNB may generally connect through the X2 link to another eNB, such as a macro eNB, through its base station controller (BSC) functionality. Thus, an LP eNB 104 may be implemented with a picocell eNB since it may be coupled to a macro eNB 104 via an X2 interface. Picocell eNBs or other such devices may incorporate some or all functionality of a macro eNB 104 or LP eNB 104. In some cases, any of these may be referred to as a base station, an “access point base station” or “enterprise femtocell.” Other embodiments may replace eNBs with base stations that perform corresponding functions but are not eNBs. In various embodiments, as part of carrier aggregation operations, a UE may communicate with a single-cell eNB via multiple frequency bands, or via multiple different cells or eNBs. As part of such operations, the network may schedule a UE to perform measurements on various adjacent cells or frequency bands, as described in more detail below. Per-CC measurement gap configurations may be used for such measurements, in accordance with various embodiments described herein.

Communication over an LTE network may be split up into 10 ms radio frames, each of which may contain ten 1 ms subframes. Each subframe of the frame, in turn, may contain two slots of 0.5 ms. Each subframe may be used for uplink (UL) communications from the UE 102 to the eNB 104 or downlink (DL) communications from the eNB 104 to the UE 102. In one embodiment, the eNB 104 may allocate a greater number of DL communications than UL communications in a particular frame. The eNB 104 may schedule transmissions over a variety of frequency bands. Each slot of the subframe may contain 6-7 OFDM symbols, depending on the system used. In one embodiment, each subframe may contain 12 subcarriers. In the 5G system or NextGen systems, however, the frame size (in ms), the subframe size, and the number of subframes within a frame, as well as the frame structure, may be different from those of a 4G or LTE system. The subframe size, as well as the number of subframes in a frame, may also vary in the 5G system from frame to frame. For example, while the frame size may remain at 10 ms in the 5G system for downward compatibility, the subframe size may be decreased to 0.2 ms or 0.25 ms to increase the number of subframes in each frame.

A downlink resource grid may be used for downlink transmissions from an eNB to a UE, while an uplink resource grid may be used for uplink transmissions from a UE to an eNB or from a UE to another UE. The resource grid may be a time-frequency grid, which is the physical resource in the downlink in each slot. The smallest time-frequency unit in a resource grid may be denoted as a resource element (RE). Each column and each row of the resource grid may correspond to one OFDM symbol and one OFDM subcarrier, respectively. The resource grid may contain resource blocks (RBs) that describe the mapping of physical channels to resource elements and physical RBs (PRBs). A PRB may be the smallest unit of resources that can be allocated to a UE. An RB in some embodiments may be 180 kHz wide in frequency and one slot long in time. In frequency, RBs may be either 12×15 kHz subcarriers or 24×7.5 kHz subcarriers wide, dependent on the system bandwidth. In frequency-division duplexing (FDD) systems, both the uplink and downlink frames may be 10 ms and frequency (full-duplex) or time (half-duplex) separated. The duration of the resource grid in the time domain corresponds to one subframe or two resource blocks. Each resource grid may comprise 12 (subcarriers)×14 (symbols)=168 resource elements.

Each OFDM symbol may contain a cyclic prefix (CP), which may be used to effectively eliminate Intersymbol Interference (ISI), and a Fast Fourier Transform (FFT) period. The duration of the CP may be determined by the highest anticipated degree of delay spread. Although distortion from the preceding OFDM symbol may exist within the CP, with a CP of sufficient duration, preceding OFDM symbols do not enter the FFT period. Once the FFT period signal is received and digitized, the receiver may ignore the signal in the CP.

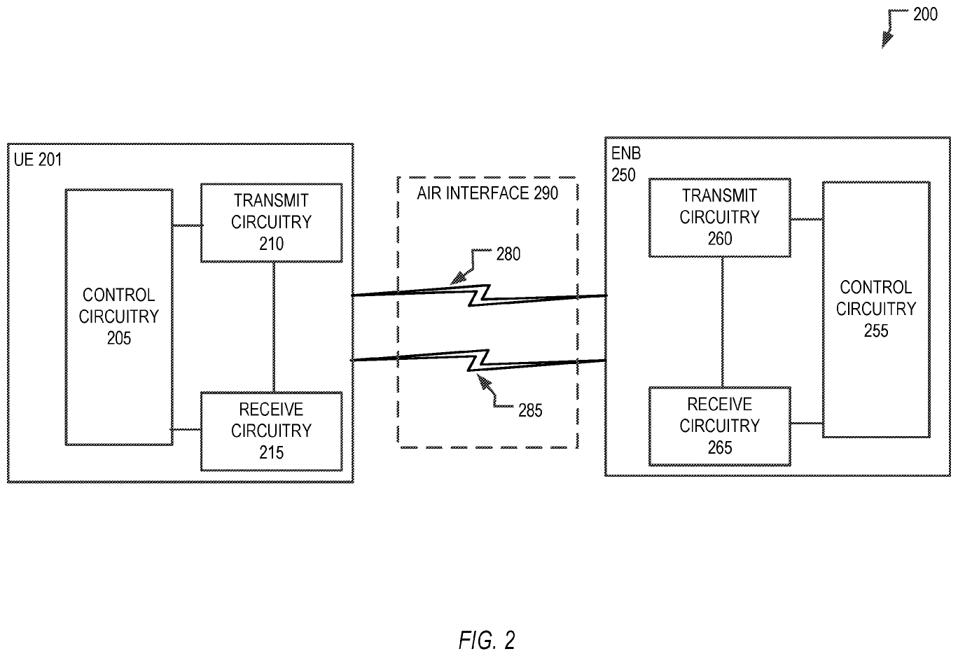

FIG. 2 illustrates components of a wireless network 200, in accordance with some embodiments. The wireless network 200 includes a UE 201 and an eNB 250 connected via one or more channels 280, 285 across a radio interface 290. The UE 201 and eNB 250 communicate using a system that supports controls for managing the access of the UE 201 to a network via the eNB 250.

In the wireless network 200, the UE 201 and any other UE in the system may be, for example, laptop computers, smartphones, tablet computers, printers, machine-type devices such as smart meters or specialized devices for healthcare monitoring, remote security surveillance systems, intelligent transportation systems, or any other wireless devices with or without a user interface. The eNB 250 provides the UE 201 network connectivity to a broader network (not shown). This UE 201 connectivity is provided via the radio interface 290 in an eNB service area provided by the eNB 250. In some embodiments, such a broader network may be a wide area network (WAN) operated by a cellular network provider, or may be the Internet. Each eNB service area associated with the eNB 250 is supported by antennas integrated with the eNB 250. The service areas are divided into a number of sectors associated with certain antennas. Such sectors may be physically associated with fixed antennas or may be assigned to a physical area with tunable antennas or antenna settings adjustable in a beamforming process used to direct a signal to a particular sector. One embodiment of the eNB 250, for example, includes three sectors, each covering an approximately 120-degree area, with an array of antennas directed to each sector to provide 360-degree coverage around the eNB 250. In various embodiments described herein, a UE may perform measurements on different cells associated with such sectors, where the measurements may or may not require the use of a measurement gap, depending on UE capabilities.

The UE 201 includes control circuitry 205 coupled with transmit circuitry 210 and receive circuitry 215. The transmit circuitry 210 and receive circuitry 215 may each be coupled with one or more antennas. The control circuitry 205 may be adapted to perform operations associated with wireless communications using congestion control. The control circuitry 205 may include various combinations of application-specific circuitry and baseband circuitry. The transmit circuitry 210 and receive circuitry 215 may be adapted to transmit and receive data, respectively, and may include radio frequency (RF) circuitry or front-end module (FEM) circuitry. In various embodiments, aspects of the transmit circuitry 210, receive circuitry 215, and control circuitry 205 may be integrated in various ways to implement the circuitry described herein. The control circuitry 205 may be adapted or configured to perform various operations such as those described elsewhere in this disclosure related to a UE. The transmit circuitry 210 may transmit a plurality of multiplexed uplink physical channels. The plurality of uplink physical channels may be multiplexed according to time-division multiplexing (TDM) or frequency-division multiplexing (FDM) along with carrier aggregation. The transmit circuitry 210 may be configured to receive block data from the control circuitry 205 for transmission across the radio interface 290. Similarly, the receive circuitry 215 may receive a plurality of multiplexed downlink physical channels from the radio interface 290 and relay the physical channels to the control circuitry 205. The plurality of downlink physical channels may be multiplexed according to TDM or FDM along with carrier aggregation. The transmit circuitry 210 and the receive circuitry 215 may transmit and receive both control data and content data (e.g., messages, images, video, etc.) structured within data blocks that are carried by the physical channels. For a device configured for low-bandwidth or irregular communications (e.g., utility meters, stationary sensors, etc.), customized circuitry and antennas may be used to enable communications on a narrow bandwidth (e.g., 180 kHz, or other similar narrow bandwidths) to enable the device to consume small amounts of network resources.

FIG. 2 also illustrates the eNB 250, in accordance with various embodiments. The eNB 250 circuitry may include control circuitry 255 coupled with transmit circuitry 260 and receive circuitry 265. The transmit circuitry 260 and receive circuitry 265 may each be coupled with one or more antennas that may be used to enable communications via the radio interface 290.

The control circuitry 255 may be adapted to perform operations for managing channels and congestion control communications used with various UEs, including communication of open mobile alliance (OMA) management objects (OMA-MOs) describing application categories, as detailed further below. The transmit circuitry 260 and receive circuitry 265 may be adapted to transmit and receive data, respectively, to and from any UE connected to the eNB 250. The transmit circuitry 260 may transmit downlink physical channels comprising a plurality of downlink subframes. The receive circuitry 265 may receive a plurality of uplink physical channels from various UEs including the UE 201. In embodiments described herein, the receive circuitry 265 may receive a plurality of uplink physical channels simultaneously on multiple unlicensed-frequency channels from a single UE.

Carrier aggregation (CA) is a technique used to increase the bandwidth between a UE and a network. This technique involves a UE communicating data over multiple different channels, with each aggregated carrier channel referred to as a component carrier. These component carriers may be adjacent carriers in a frequency band, or may be spread among any frequencies available to a communication system.

In order to facilitate smooth network transitions (e.g., cell handovers, redirection, reselection, or the like) with a high quality of experience (QoE), the UE has the capability to measure surrounding cells and provide related data to the network. In network deployment situations there may be many frequencies, and some of the frequency carriers can be micro cells that have been deployed back-to-back in dense network deployments as described above. However, the UE may not be able to switch to those cells as a result of a large load within the macro cell, for example. As a result of a large network deployment density, the UE may not be able to access these small cells depending on the location of the UE. If the UE misses chances of measuring small-cell frequency carriers, it might not have a backup network available. Additionally, if it misses measurements of the macro layers, the UE may not be able to hand over fast enough and a call could drop.

As part of standard communication system operations, a network may have a UE perform measurements on various frequency bands and various cells of eNBs close to the UE. For simple systems with one antenna and a single receive (Rx) and transmit (Tx) system, a “measurement gap” is scheduled within the data transmissions between the UE and the network to enable the UE to perform the measurements. A “measurement gap pattern” can refer to the pattern of measurement gaps that the UE can facilitate frequency carrier (e.g., CC) measurements on within a time period or duration. The UE, for example, can operate during a measurement gap to switch from a serving band it is connected on to a different band (or CC) in order to perform a measurement of the (component) carrier. The term “serving band” as used herein means a band to which the UE is connected to receive downlink data on; in this case no measurement is necessarily required in that band because the UE is already operating in or on that band.

For UEs with multiple communication Rx and Tx chains and a large number of CA channels, a measurement gap is not always needed, and the circumstances under which a measurement gap is needed may be complex. As the band combinations in CA systems increase, the measurement gap requirements also become more complex, and are further complicated by device hardware (e.g., digitizers, filters, or other components that may be shared among channels for processing multiple component carriers). Due to such complexities, a standard measurement gap for every measurement to be performed by a UE is inefficient. For example, some embodiments described herein avoid wasting resources (e.g., bandwidth and power) on unnecessary measurement gaps by using measurement gaps that are configured on a per-component carrier basis.

Embodiments described herein include measurement gap enhancements. One such enhancement is the use of per-component carrier configuration of gaps, with per-component carrier (per-CC) configuration of gaps in carrier aggregation (CA)/dual connectivity (DC), such that identical gap configuration is not required on all serving cells to make measurements under the assumption that the user equipment (UE) has multiple radio frequency (RF) chains. In some embodiments, it is possible for UEs with multiple RF chains to measure more than one measurement object. The capability to do this may depend on both baseband and RF architectures.

Procedures for signaling per-CC measurement gap(s) in some embodiments include the following three options: Option A: an RF chain capability approach; Option B: per-CA capability signaling which in some embodiments may further include a per-CC combination; and Option C: capability for the UE to transmit feedback (“feedbacks”) after the network has configured the measurement object.

In various embodiments of Option C, the UE sends the measurement gap preference to the network based on the configured CA after the network has received the UE capability. A UE may indicate such a preference in the Radio Resource Control (RRC) Connection Reconfiguration Complete message. Embodiments may include two sub-options. In option C1, the network assumes that the measurement gap configuration from the UE preference is final if the network determines that the configuration is acceptable or permitted. In this case, there may be no RRC reconfiguration, since the RRC reconfiguration may not be needed. In option C2, the network may perform RRC reconfiguration to configure the measurement gap after the UE indicates the preference. In this case, additional signaling overhead may be needed.

Various embodiments discussed herein may be based on the same or a similar understanding of the above examples. Some embodiments may also address UE capability size concerns. Further still, some embodiments discussed herein provide stage 3 signaling of network-controlled small gaps (NCSG) and per-CC measurement gaps.

As part of the above, some embodiments herein thus describe per-CC configuration of gaps in carrier aggregation/dual connectivity, such that identical gap configuration is not required on all serving cells to make measurements under the assumption that the UE has multiple RF chains. Additionally, various embodiments may combine such operations with the use of measurement gaps for interruption control to avoid autonomous interruptions that UEs may make in certain scenarios. Additionally, per-CC gap configuration may also use shorter-measurement graph length (MGL) measurement gaps in some embodiments, which may be used to make measurements when there is a known or approximately known timing relationship between serving frequency/frequencies and target frequencies to be measured. In such embodiments, the gap can be shorter than 6 ms while still allowing neighbor primary synchronization signals (PSS) and secondary synchronization signals (SSS) to be detected as part of measurement operations.

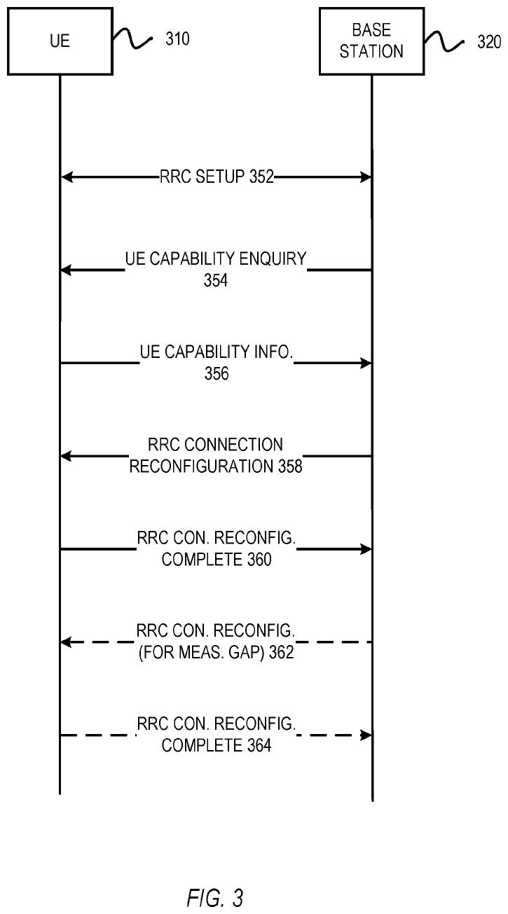

FIG. 3 illustrates operations and communications for per-component carrier measurement gap operations and network-controlled small-gap signaling, in accordance with some embodiments. Such operations occur with illustrated communications between a UE 310 and a base station 320 (e.g., an eNB, next-generation nodeB (gNB), or other such device), and further involve processing (e.g., encoding and decoding along with any other operations) performed by these devices along with the associated communications. In operation 352, an RRC setup procedure is performed. Then, in operation 354, a UE capability enquiry is performed, which may involve the base station 320 sending or transmitting a UE capability enquiry message to the UE 310, which may be used to request the transfer of UE 310 radio access capabilities and/or other UE capabilities. The UE capability enquiry message may include a requestedFrequencyBands field or information element (IE) to provide a list of frequency bands for which the UE 310 is requested to provide supported CA band combinations and non-CA bands.

Operation 356 includes the UE 310 sending/transmitting a UE capability information message to the base station 320 (e.g., eNB/gNB), which may include a CA band combination capability supported by the UE 310. Operation 358 includes the base station 320 sending/transmitting an RRC connection reconfiguration message (e.g., an RRCConnectionReconfiguration message) to the UE 310. In operation 358, the network may configure the UE 310 with the CA configuration with an optional indication that the UE 310 can indicate the per-CC measurement gap preference(s).

Operation 360 includes the UE 310 sending/transmitting, to the base station 320, an RRC reconfiguration complete message along with a gap configuration based on the CA configuration in operation 358, if the network has indicated that the UE 310 can indicate the per-CC measurement gap preference(s) in operation 358. Operation 362 includes the base station 320 sending/transmitting an RRC connection reconfiguration message to the UE 310. Operation 362 may include the network (optional or mandatory) performing reconfiguration on the measurement gap. Operation 364 includes the UE 310 sending/transmitting, to the base station 320, an RRC reconfiguration complete message.

In various embodiments associated with option C2 described above, a system may have signaling overhead for the RRC reconfiguration. In embodiments, option C1 or C2 may be used for signaling per-CC configuration of gaps. Additionally, some embodiments may include a new per-CC measurement gap configuration request message added to the RRCConnectionReconfiguration message. In such embodiments, the UE 310 may indicate the per-CC measurement gap configuration in the RRCConnectionReconfigurationComplete message.

Regardless of which option is used, the signaling may need to support network configuration of per-CC measurement gaps. Below are example descriptions of fields and information elements which may be used in operations by the UE 310 and the base station 320 in accordance with various embodiments for per-CC and NCSG configurations. Example details in accordance with some embodiments are:

```
RRCConectionReconfiguration-v14x0-IEs ::= SEQUENCE {
  s1-V2X-ConfigDedicated-r14 SL-V2x-ConfigDedicated-r14 OPTIONAL,
--Need ON
  nonCriticalExtension RRCConnectionReconfiguration-vlxyz-
IE [symbol]
    OPTIONAL
}
RRCConnectionReconfiguration-vlxyz-IEs ::= SEQUENCE {
  perCCGapIndicationRequest ENUMERATED{TRUE} OPTIONAL,
  nonCriticalExtension SEQUENCE { } OPTIONAL
}
```

p-SeNB
Indicates the guaranteed power for the SeNB as specified in TS 36.213 [23, Table 5.1.4.2-1]. The value N corresponds to N−1 in TX 36.213 [23].

### per CCGapindicationRequest

Indicates the UE can send per CC measurement gap configuration in the RRCConnectionReconfigurationComplete message
rclwi-Configuration
WLAN traffic steering command as specified in 5.6.16.2. E-UTRAN does not simultaneously configure RCLWI with DC, LWA or LWIP for a UE.

```
RRCConectionReconfigurationComplete-v1250-Ies ::= SEQUENCE {
  logMeasAvalableMBSFN-r12 ENUMERATED {true} OPTIONAL,
  nonCriticalExtension RRCConnectionReconfigurationComplete-vlxyz-
IE [symbol]
    OPTIONAL
}
RRCConnectionReconfigurationComplete-vlxyz-IEs ::= SEQUENCE {
  perCCGapIndication MeasPerCCListGapConfig-r14
OPTIONAL,
  nonCriticalExtension SEQUENCE { } OPTIONAL
}
```

-- ASN1START

| | |
|---|---|
| MeasGapConfig ::= | CHOICE { |
| release | NULL, |
| setup | SEQUENCE { |
| gapOffset | CHOICE { |
| gp0 | INTEGER (0. . 39), |
| gp1 | INTEGER (0. . 79), |
| gp2 | INTEGER (0. . 39), |
| gp3 | INTEGER (0. . 79), |
| . . . | |
| gp4 | MeasPerCCListGapConfig-r14 |
| } | |
| } | |
| } | |

| | |
|---|---|
| MeasPerCCListGapConfig-r14 ::= | SEQUENCE (SIZE (1..maxServCell- |

r13))

OF MeasPerCCGapConfig-r14

| | |
|---|---|
| MeasPerCCGapConfig-r14 ::= | SEQUENCE { |
| servCellId | ServCellIndex-r13, |
| gapOffset | CHOICE { |
| gp0 | INTEGER (0. . 39), |
| gp1 | INTEGER (0. . 79), |
| gp2 | INTEGER (0. . 39), |
| gp3 | INTEGER (0. . 79), |

} OPTIONAL,

| | |
|---|---|
| nesg-gapOffset | CHOICE { |
| gp0-NCSG-r14 | INTEGER (0. . 39), |
| gp1-NCSG-r14 | INTEGER (0. . 79), |
| gp2-NCSG-r14 | INTEGER (0. . 39), |
| gp3-NCSG-r14 | INTEGER (0. . 79), |
| } OPTIONAL, | |
| . . . | |
| } | |

### MeasGapConfig Field Descriptions

gapOffset
Value gapOffset of gp0 corresponds to gap offset of Gap Pattern Id “0” with MGRP=40 ms, gapOffset of gp1 corresponds to gap offset of Gap Pattern Id “1” with MGRP=80 ms. Also used to specify the measurement gap pattern to be applied, as defined in TX 36.133[16].
Value gapOffset of gp2 corresponds to gap offset of Gap Pattern Id “2” with MGRP=40 ms with 3 ms gap duration for measurement. gapOffset of gp 3 corresponds to gap offset of Gap Pattern Id “3” with MGRP—80 ms with 3 ms gap duration for measurement. Value gapOffset gp4 corresponds to per cc measurement gap configuration
ncsg-gapOffset
Value ncsg-gapOffset of gp0-NCSG corresponds to gap offset of NCSG Pattern Id “1” with MGRP=40 ms with visible interruption length—1 ms before measurement, as defined in TS 36.133[16]. ncsg-gapOffset of gp1-NCSG corresponds to gap offset of NCSG Pattern ID ‘2’ with MGRP=80 ms with visible interruption length=1 ms before measurement. ncsg-gapOffset of gp2-NCSG corresponds to gap offset of NCSG Pattern ID “3” with MGRP=80 ms with visible interruption length=2 ms before measurement. ncsg-gapOffset of gp3-NCSG corresponds to gap offset of NCSG Pattern Id “4” with MGRP=80 ms with visible interruption length—2 ms before measurement
servCellIdList
serving cell ID corresponds to Pcell and S Cell
Note: in case of per CC measurement gap is configured:
(1) only single MGL is allowed to configured per UE across different cc.
(2) when gapOffset=gp2 or gp3, ncsg-gapOffset should not be configured to the UE.
(3) ncsg-gapOffset can only be configured when gapOffset is not configured of gapOffset=gp1.

UE-EUTRA-Capability-v14xy-IEs ::= SEQUENCE {

| | |
|---|---|
| 1aa-Parameters-v14xy | LAA-Paremeters-v14xy |

OPTIONAL,

| | |
|---|---|
| nonCriticalExtension | UE-EUTRA-Capability-vxxy-IEs |

```
  OPTIONAL
}
UE-EUTRA-Capability-vxxy-IEs ::= SEQUENCE {
  ue-support-ncsg-R14 ENUMERATED {true} OPTIONAL,
  ue-support-perCCGap-r14 ENUMERATED {true} OPTIONAL,
  nonCriticalExtension SEQUENCE { } OPTIONAL
}
```

ue-supportedperCCGap-r14
Indicates whether the UE supports per CC measurement gap
ue-support-ncsg-r14
Indicates whether the UE supports NCSG measurement gap
ue-TxAngennaSelectionSupported

Alternatively, the network may configure one measurement gap for all CCs and the UE 310 may only indicate no gap per-CC or NCSG per-CC. In this case, the UE 310 may indicate the following:

| | |
|---|---|
| MeasPerCCListGapConfig-r14 ::= | SEQUENCE (SIZE (1..maxServCell-r13)) |

OF MeasPerCCGapConfig-r14;

| | |
|---|---|
| MeasPerCCGapConfig-r14 ::= | SEQUENCE { |

| | |
|---|---|
| servCellId | ServCellIndex-r13, |

| | |
|---|---|
| ncsg-gapOffset | CHOICE { |
| gp0-NCSG-r14 | INTEGER (0..39), |
| gp1-NCSG-r14 | INTEGER (0..79), |
| gp2-NCSG-r14 | INTEGER (0..39), |
| gp3-NCSG-r14 | INTEGER (0..79), |

| | |
|---|---|
| noGapNeed | ENUMATED {true} |

```
  } OPTIONAL,
  ...
}
```

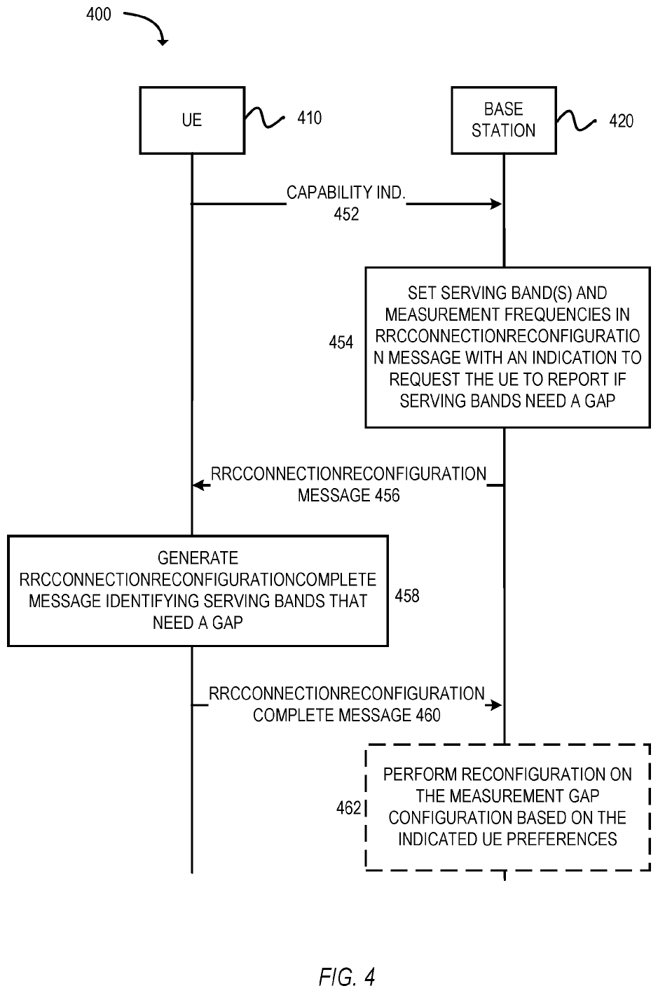

FIG. 4 illustrates operations 400 for per-component carrier measurement gap configuration, in accordance with some embodiments. FIG. 4 includes a UE 410 communicating with a base station 420 that is part of a network. In some embodiments, the operations performed by the base station 420 may be performed by processing circuitry of the eNB of the base station 420. In other embodiments, other elements of the base station 420 may perform some of the reconfiguration operations described in FIG. 4. In FIG. 4, the operations 400 begin with operation 452, where the UE 410 indicates a capability that it supports a per-CC measurement gap feature. In operation 454, the base station 420 configures the serving band(s) and measurement frequencies in an RRCConnectionReconfiguration message, along with an indication to request the UE 410 to report if the serving band needs a gap or not. This RRCConnectionReconfiguration message is then sent from the eNB of the base station 420 to the UE 410 in operation 456.

When the UE 410 receives the RRCConnectionReconfiguration message and decodes the message to identify the perCCgapRequest, the UE 410 then generates an RRCConnectionReconfigurationComplete message in operation 458. In operation 460, the UE 410 then sends the RRCConnectionReconfigurationComplete message in response, identifying whether each serving band needs a gap or not in a bit string based on the configured serving band, the frequency used to make measurements, and the UE Rx chain capability.

Following receipt of the RRCConnectionReconfigurationComplete message at the eNB of the base station 420, in some embodiments, optional operation 462 involves the base station 420 then performing reconfiguration on the measurement gap configuration based on the UE 410 preferences. In some such embodiments, a measConfig IE or other associated configuration settings at the base station 420 are extended to include extended data. Otherwise, the base station 420 can use the bit string the UE 410 sends to infer if the measurement gap is needed or not.

In some embodiments, information on a UE capability and the need for information gaps in certain circumstances may be stored in a table at the UE, and used to respond to a perCCgapRequest. This information may be used in different ways to respond to the perCCgapRequest in different embodiments. When a UE signals a response for all carrier aggregation combinations, this does not necessarily cover all measurement possibilities.

Various settings in some embodiments are structured as data strings for inclusion in an IE communicated to a network to inform the network of the UE preferences for per-CC gap configurations based on UE capabilities. In some embodiments, additional information may be based on different UE modes, with tables including information for given frequency bands under a normal operating mode and a low-power operating mode when an Rx chain may be powered down. In other embodiments, any other such modes may be supported, with each mode having corresponding per-CC measurement gap preferences. Some or all of such preferences may be communicated from a UE to the network in various different systems.

In addition, some embodiments may operate with an alternative extended measConfig to indicate which serving bands don't need a gap. Such embodiments may use new signaling to indicate this preference.

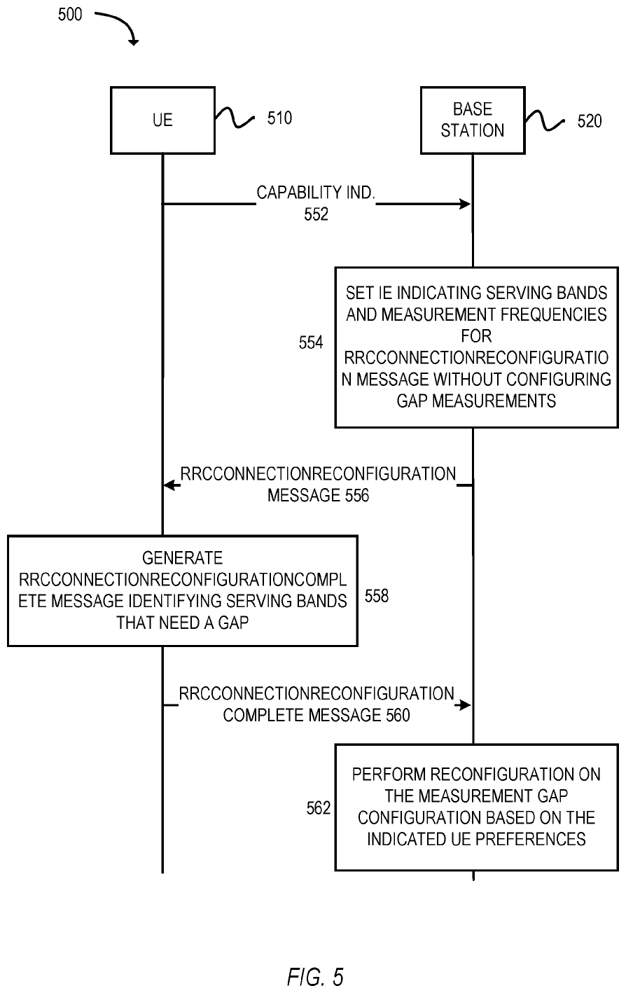

FIG. 5 illustrates additional operations 500 for per-component carrier measurement gap configurations, in accordance with some embodiments. FIG. 5 includes a UE 510 and a base station 520 that is part of a network. In operation 552, the UE 510 indicates the capability that the UE 510 supports a per-CC measurement gap feature. Following this indication, in operation 554, the base station 520 indicates in a new IE the serving band(s) and measurement frequencies in an RRCConnectionReconfiguration message. No gap measurement configuration is set at this point (e.g., in contrast to operation 454, where an initial measurement gap configuration may be set). In operation 556, the base station 520 communicates the RRCConnectionReconfiguration message, and in operation 558 the UE 510 responds by generating an RRCConnectionReconfigurationComplete message identifying serving bands that need a gap. The UE 510 then sends the RRCConnectionReconfigurationComplete message in operation 560 to identify whether each serving band needs a gap or not in a bit string based on a configured serving band, a frequency to be measured, and the UE Rx chain capability. In operation 562, the base station 520 then performs reconfiguration on the measurement gap configuration based on the UE preference.

In some such embodiments, per-CC and network-controlled small-gap (NCSG) indications may be sent together. In such embodiments, similar alternatives may be used with modifications in the IE.

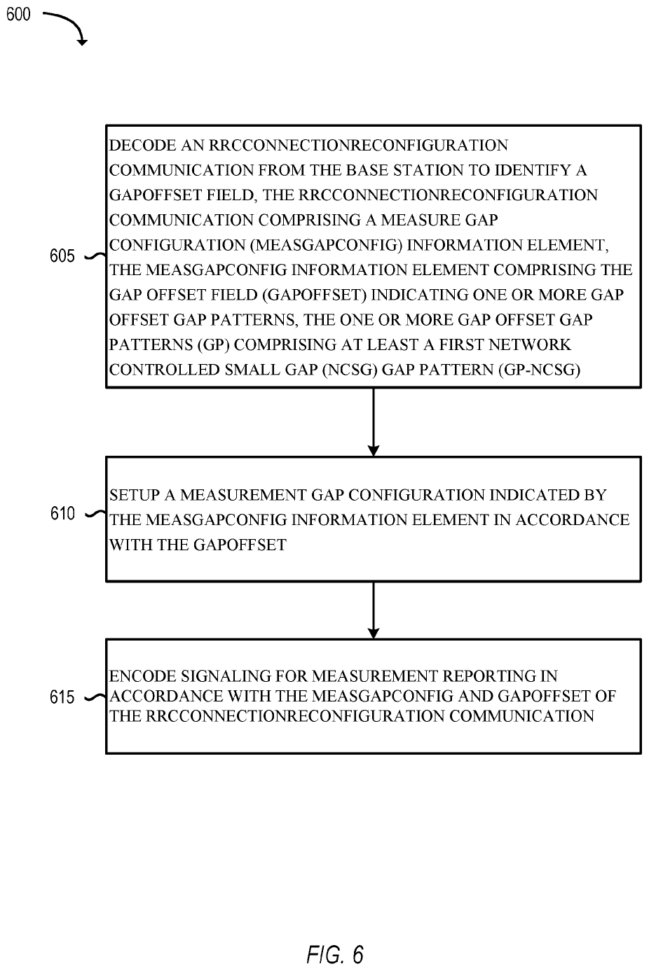

FIG. 6 illustrates an example method 600 performed by a UE (e.g., the UE 102, 201, 310, etc.), in accordance with embodiments described herein. In some embodiments, the method 600 of FIG. 6 may be implemented by one or more processors of a UE or an apparatus of any UE or machine that includes processing circuitry. In other embodiments, the method 600 may be implemented as computer-readable instructions in a storage medium that, when executed by one or more processors of a device, cause the device to perform the method 600.

The method 600 begins with operation 605 to decode or otherwise process an RRCConnectionReconfiguration communication from a base station to identify a gapOffset field. The RRCConnectionReconfiguration communication comprises a measure gap configuration (MeasGapConfig) information element, the MeasGapConfig information element comprising a gap offset field (gapOffset) indicating one or more gap offset gap patterns, the one or more gap offset gap patterns (gp) comprising at least a first network-controlled small-gap (ncsg) gap pattern (gp-ncsg). In various embodiments, such information elements and fields of a communication may be received at an antenna of the UE and relayed to the processing circuitry via various intermediate circuit, interface, and processing elements as described herein. Then, operation 610 involves setting a measurement gap configuration indicated by the MeasGapConfig information element in accordance with the gapOffset, and operation 615 involves encoding signaling for measurement reporting in accordance with the MeasGapConfig and gapOffset of the RRCConnectionReconfiguration communication. Additionally, further processing and encoding/decoding in accordance with the operations above may be performed for any information element or field described above.

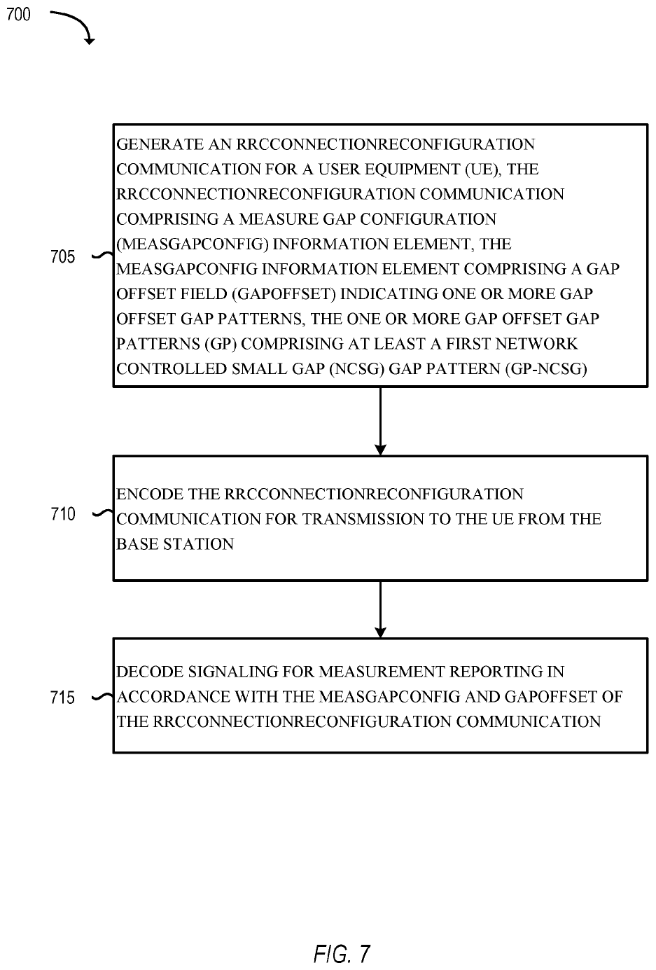

FIG. 7 illustrates an example method 700 that may be performed by a base station or an apparatus of a base station with processing circuitry, in accordance with embodiments described herein. The method 700 may, for example, be a complementary operation performed by an apparatus of a base station while a corresponding UE performs the method 600. In some embodiments, processors of different devices within a network other than a base station may perform some or all of the operations of the method 700. In other embodiments, the method 700 may be implemented as computer-readable instructions in a storage medium that, when executed by one or more processors of one or more base station devices (e.g., an eNB or other device of a 3GPP network), cause the one or more devices to perform the method 700.

The method 700 begins with operation 705 to generate an RRCConnectionReconfiguration communication for a user equipment (UE), the RRCConnectionReconfiguration communication comprising a measure gap configuration (MeasGapConfig) information element, the MeasGapConfig information element comprising a gap offset field (gapOffset) indicating one or more gap offset gap patterns, the one or more gap offset gap patterns (gp) comprising at least a first network-controlled small-gap (ncsg) gap pattern (gp-ncsg). As described above, in various embodiments, the RRCConnectionReconfiguration communication may be generated or otherwise assembled at the base station, or in any other device in accordance with the particular operations of a network. Operation 710 then involves encoding (e.g., processing) the RRCConnectionReconfiguration communication for transmission to the UE from the base station, and operation 715 involves decoding (e.g., processing) signaling for measurement reporting in accordance with the MeasGapConfig and gapOffset of the RRCConnectionReconfiguration communication. The measurement information may then be used to further configure communications based on the results of the measurements reported to the base station.

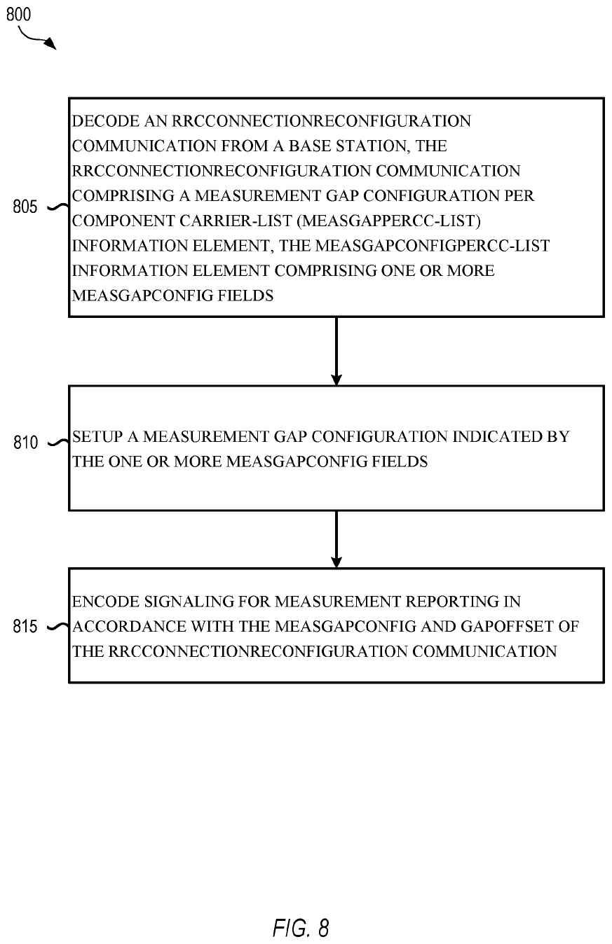

FIG. 8 illustrates an example method 800 performed by a UE (e.g., the UE 102, 201, 310, etc.), in accordance with embodiments described herein. In some embodiments, the method 800 of FIG. 8 may be implemented by one or more processors of a UE or an apparatus of any UE or machine that includes processing circuitry. In other embodiments, the method 800 may be implemented as computer-readable instructions in a storage medium that, when executed by one or more processors of a device, cause the device to perform the method 800.

The method 800 begins with operation 805 to decode an RRCConnectionReconfiguration communication from a base station, the RRCConnectionReconfiguration communication comprising a measurement gap configuration per component carrier-list (MeasGapConfigPerCC-list) information element, the MeasGapConfigPerCC-list information element comprising one or more MeasGapConfig fields. Then operation 810 involves setup of a measurement gap configuration indicated by the one or more MeasGapConfig fields, and operation 815 involves encoding signaling for measurement reporting in accordance with the MeasGapConfig and gapOffset of the RRCConnectionReconfiguration communication.

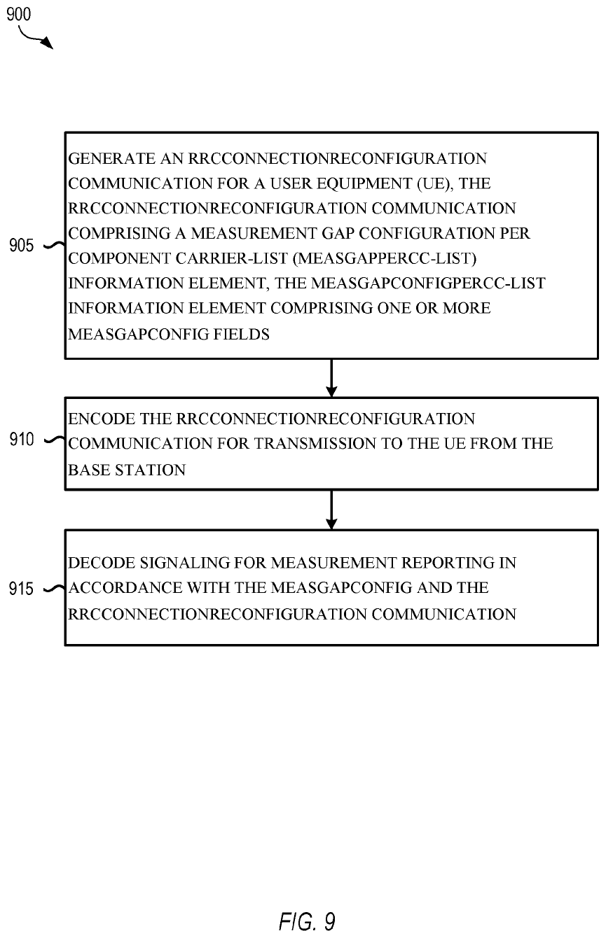

Similarly, FIG. 9 illustrates an example method 900 that may be performed by a base station or an apparatus of a base station with processing circuitry, in accordance with embodiments described herein. The method 900 may, for example, be a complementary method performed by an apparatus of a base station while a corresponding UE performs the method 800. In some embodiments, processors of different devices within a network other than a base station may perform some or all of the operations of the method 900. In other embodiments, the method 900 may be implemented as computer-readable instructions in a storage medium that, when executed by one or more processors of one or more base station devices (e.g., an eNB or other device of a 3GPP network), cause the one or more devices to perform the method 900.

The method 900 begins with operation 905 to generate an RRCConnectionReconfiguration communication for a user equipment (UE), the RRCConnectionReconfiguration communication comprising a measurement gap configuration per component carrier-list (MeasGapConfigPerCC-list) information element, the MeasGapConfigPerCC-list information element comprising one or more MeasGapConfig fields. Operation 910 then involves encoding the RRCConnectionReconfiguration communication for transmission to the UE from the base station, and operation 915 involves decoding signaling for measurement reporting in accordance with the MeasGapConfig and the RRCConnectionReconfiguration communication.

The methods 600, 700, 800, and 900 describe particular embodiments, but it will be apparent that additional methods, in accordance with the embodiments described herein, are possible with repeated or intervening operations to achieve UE provisioning. For example, additional embodiments of operations at a UE are described above, and it will be apparent that corresponding eNB or base station operations other than those of the methods 700 and 900 will occur in conjunction with the described operations. Further still, any embodiments described above may be performed with repeated operations or intervening operations in various different embodiments. Additionally, some embodiments may include UEs that perform both methods 600 and 800 with various combinations of the described operations, and corresponding operations at a base station. Any of these operations may then additionally involve generation or processing of communications, information elements, and/or fields described above in addition to the particular communications, information elements, and fields of the above methods. An additional set of non-exhaustive embodiments is further presented below.

### Example Embodiments

Example 1 may include a method comprising sending, by a network, a request for a UE to indicate a per-CC measurement gap configuration in an RRC connection reconfiguration message.

Example 2 may include the method of example 1 and/or some other examples herein, wherein the UE sends the per-CC measurement gap configuration in an RRC connection reconfiguration complete message.

Example 3 may include the method of examples 1-2 and/or some other examples herein, wherein the network optionally performs measurement gap reconfiguration after receiving the UE per-CC measurement gap preference.

Example 4 may include the method of examples 1-3 and/or some other examples herein, wherein a MeasGapConfig is extended to include a per-CC measurement gap.

Example 5 may include the method of examples 1-4 and/or some other examples herein, wherein the per-CC measurement gap configuration is a list of configurations with a maximum size of maxservingcell.

Example 6 may include the method of examples 1-5 and/or some other examples herein, wherein the per-CC measurement gap configuration includes a serving cell ID, and a gap pattern with options of legacy gap gp0 and gp 1 and shorter gap gp2 and gp3.

Example 7 may include the method of examples 1-6 and/or some other examples herein, wherein the per-CC measurement gap configuration includes an ncsg gap pattern which indicates 40 ms, 80 ms, and 1 ms interruption or 2 ms interruption according to a RAN4 spec.

Example 8 may include the method of examples 1-7 and/or some other examples herein, wherein the UE capability is to support ncsg.

Example 9 may include the method of examples 1-8 and/or some other examples herein, wherein the UE capability is to support a per-CC measurement gap.

Example 10 may include the method of examples 1-3 and/or some other examples herein, wherein the network configures only one gap (either a legacy gap or a short gap) and the UE sends a per-CC gap indication with each CC with either (ncsg gap or no gap needed).

Example 11 may include an apparatus comprising means to perform one or more elements of a method described in or related to any of examples 1-10, or any other method or process described herein.

Example 12 may include one or more computer-readable media comprising instructions to cause an electronic device, upon execution of the instructions by one or more processors of the electronic device, to perform one or more elements of a method described in or related to any of examples 1-10, or any other method or process described herein.

Example 13 may include an apparatus comprising logic, modules, and/or circuitry to perform one or more elements of a method described in or related to any of examples 1-10, or any other method or process described herein.

Example 14 may include a method, technique, or process as described in or related to any of examples 1-10, or portions or parts thereof.

Example 15 may include an apparatus comprising one or more processors and one or more computer-readable media comprising instructions that, when executed by the one or more processors, cause the one or more processors to perform a method, technique, or process as described in or related to any of examples 1-10, or portions thereof.

Example 16 may include a method of communicating in a wireless network as shown and described herein.

Example 17 may include a system for providing wireless communication as shown and described herein.

Example 18 may include a device for providing wireless communication as shown and described herein.

Example 19 is an apparatus of a user equipment (UE), the apparatus comprising: a memory configured to store an RRCConnectionReconfiguration communication from a base station, the RRCConnectionReconfiguration communication comprising a measure gap configuration (MeasGapConfig) information element, the MeasGapConfig information element comprising a gap offset field (gapOffset) indicating one or more gap offset gap patterns, the one or more gap offset gap patterns (gp) comprising at least a first network-controlled small-gap (ncsg) gap pattern (gp-ncsg); and processing circuitry coupled to the memory and configured to: decode the RRCConnectionReconfiguration communication from the base station to identify the gapOffset field; and set up a measurement gap configuration indicated by the MeasGapConfig information element in accordance with the gapOffset.

In Example 20, the subject matter of Example 19 optionally includes wherein the processing circuitry is configured to encode signaling for measurement reporting in accordance with the MeasGapConfig information element and gapOffset of the RRCConnectionReconfiguration communication.

In Example 21, the subject matter of any one or more of Examples 19-20 optionally include wherein the RRCConnectionReconfiguration communication further comprises a field for a per-component carrier gap indication request (perCCgapRequest) requesting measurement gap preferences of the UE per component carrier; and wherein the processing circuitry is further configured to: decode the RRCConnectionReconfiguration communication from the base station to identify the PerCCgapRequest; set content of an RRCConnectionReconfigurationComplete message to include an indication of the measurement gap preferences of the UE per component carrier in response to the PerCCgapRequest; and initiate transmission of the RRCConnectionReconfigurationComplete message comprising the measurement gap preferences of the UE per component carrier to the base station.

In Example 22, the subject matter of any one or more of Examples 19-21 optionally include wherein the gapOffset comprises a first value indicating a per-component carrier measurement configuration.

In Example 23, the subject matter of any one or more of Examples 19-22 optionally include wherein the RRCConnectionReconfiguration communication comprises a measurement gap configuration per component carrier-list (MeasGapConfigPerCC-list) information element, the MeasGapConfigPerCC-list information element comprising at least the MeasGapConfig information element.

In Example 24, the subject matter of any one or more of Examples 19-23 optionally include wherein the gapOffset comprises at least three values, each value of the gapOffset associated with different gap pattern settings.

In Example 25, the subject matter of Example 24 optionally includes wherein the gapOffset comprises a gp2 value corresponding to a measurement gap repetition period (MGRP) value of 40 ms and a 3 ms gap duration for measurement.

In Example 26, the subject matter of Example 25 optionally includes wherein the gapOffset comprises a gp3 value corresponding to an MGRP value of 80 ms and a 3 ms gap duration for measurement.

In Example 27, the subject matter of Example 26 optionally includes wherein the gapOffset comprises a gp4 value corresponding to a per-component carrier gap configuration.

In Example 28, the subject matter of any one or more of Examples 19-27 optionally include wherein the MeasGapConfig information element comprises a serving cell identifier (ID) list associated with a corresponding PCell and SCell.

In Example 29, the subject matter of any one or more of Examples 19-28 optionally include wherein the processing circuitry is further configured to: decode a UE capability enquiry from the base station; and in response to the UE capability enquiry, communicate a support-NCSG-r14 response indicating that the UE supports NCSG measurement gap operation.

In Example 30, the subject matter of Example 29 optionally includes wherein the processing circuitry is further configured to: process an RRC Setup with the base station prior to receipt of the UE capability enquiry; wherein the UE further communicates a list of supported carrier aggregation band combinations and non-carrier aggregation bands in response to the UE capability enquiry prior to processing of the RRCConnectionReconfiguration communication; and wherein the RRCConnectionReconfiguration communication from the base station is generated at least in part based on the list of supported carrier aggregation band combinations from the UE.

In Example 31, the subject matter of any one or more of Examples 19-30 optionally include further comprising: radio frequency circuitry coupled to the processing circuitry; and one or more antennas coupled to the radio frequency circuitry and configured to receive the RRCConnectionReconfiguration communication from the base station.

Example 32 is a computer-readable medium comprising instructions that, when executed by one or more processors of a User Equipment (UE), cause the UE to: decode an RRCConnectionReconfiguration communication from a base station to identify a gap offset field, the RRCConnectionReconfiguration communication comprising a measure gap configuration (MeasGapConfig) information element, the MeasGapConfig information element comprising the gap offset field (gapOffset) indicating one or more gap offset gap patterns, the one or more gap offset gap patterns (gp) comprising at least a first network-controlled small-gap (ncsg) gap pattern (gp-ncsg); set up a measurement gap configuration indicated by the MeasGapConfig information element in accordance with the gapOffset; and encode signaling for measurement reporting in accordance with the MeasGapConfig information element and gapOffset of the RRCConnectionReconfiguration communication.

In Example 33, the subject matter of Example 32 optionally includes wherein the gapOffset comprises at least three values, each value of the gapOffset associated with different gap pattern settings; wherein the gapOffset comprises a gp2 value corresponding to an MGRP value of 40 ms and a 3 ms gap duration for measurement; and wherein the MeasGapConfig information element comprises a serving cell identifier (ID) list associated with a corresponding PCell and SCell.

In Example 34, the subject matter of any one or more of Examples 32-33 optionally include wherein the instructions further configure the UE to: decode a UE capability enquiry from the base station; in response to the UE capability enquiry, communicate a support-NCSG-r14 response indicating that the UE supports NCSG measurement gap operation; and process an RRC Setup with the base station prior to receipt of the UE capability enquiry; wherein the UE further communicates a list of supported carrier aggregation band combinations and non-carrier aggregation bands in response to the UE capability enquiry prior to processing of the RRCConnectionReconfiguration communication; and wherein the RRCConnectionReconfiguration communication from the base station is generated at least in part based on the list of supported carrier aggregation band combinations from the UE.

Example 35 is an apparatus of a base station, the apparatus comprising: processing circuitry configured to: generate an RRCConnectionReconfiguration communication for a user equipment (UE), the RRCConnectionReconfiguration communication comprising a measure gap configuration (MeasGapConfig) information element, the MeasGapConfig information element comprising a gap offset field (gapOffset) indicating one or more gap offset gap patterns, the one or more gap offset gap patterns (gp) comprising at least a first network-controlled small-gap (ncsg) gap pattern (gp-ncsg); encode the RRCConnectionReconfiguration communication for transmission to the UE from the base station; and decode signaling for measurement reporting in accordance with the MeasGapConfig information element and gapOffset of the RRCConnectionReconfiguration communication; and an interface coupled to the processing circuitry and configured to: transmit the RRCConnectionReconfiguration communication; and receive the signaling for the measurement reporting.

In Example 36, the subject matter of Example 35 optionally includes wherein the gapOffset comprises a first value indicating a per-component carrier measurement configuration.

In Example 37, the subject matter of Example 36 optionally includes wherein the RRCConnectionReconfiguration communication comprises a measurement gap configuration per component carrier-list (MeasGapConfigPerCC-list) information element, the MeasGapConfigPerCC-list information element comprising at least the MeasGapConfig information element.

Example 38 is a computer-readable medium comprising instructions that, when executed by one or more processors of a base station, cause the base station to: generate an RRCConnectionReconfiguration communication for a user equipment (UE), the RRCConnectionReconfiguration communication comprising a measure gap configuration (MeasGapConfig) information element, the MeasGapConfig information element comprising a gap offset field (gapOffset) indicating one or more gap offset gap patterns, the one or more gap offset gap patterns (gp) comprising at least a first network-controlled small-gap (ncsg) gap pattern (gp-ncsg); encode the RRCConnectionReconfiguration communication for transmission to the UE from the base station; and decode signaling for measurement reporting in accordance with the MeasGapConfig information element and gapOffset of the RRCConnectionReconfiguration communication.

In Example 39, the subject matter of Example 38 optionally includes wherein the gapOffset comprises at least three values, each value of the gapOffset associated with different gap pattern settings.

In Example 40, the subject matter of any one or more of Examples 38-39 optionally include wherein the MeasGapConfig information element comprises a serving cell identifier (ID) list associated with a corresponding PCell and SCell.

Example 41 is an apparatus of a user equipment (UE), the apparatus comprising: a memory configured to store an RRCConnectionReconfiguration communication from a base station, the RRCConnectionReconfiguration communication comprising a measurement gap configuration per component carrier-list (MeasGapConfigPerCC-list) information element, the MeasGapConfigPerCC-list information element comprising one or more MeasGapConfig fields; and processing circuitry coupled to the memory and configured to: decode the RRCConnectionReconfiguration communication from the base station to identify the one or more MeasGapConfig fields; and set up a measurement gap configuration indicated by the one or more MeasGapConfig fields.

In Example 42, the subject matter of Example 41 optionally includes wherein the processing circuitry is further configured to: decode a UE capability enquiry from the base station; and in response to the UE capability enquiry, communicate a support-perCCGap response indicating that the UE supports per-component carrier measurement gap operation.

In Example 43, the subject matter of any one or more of Examples 41-42 optionally include wherein the processing circuitry is further configured to encode signaling for measurement reporting in accordance with the one or more MeasGapConfig fields of the RRCConnectionReconfiguration communication.

In Example 44, the subject matter of any one or more of Examples 41-43 optionally include wherein the one or more MeasGapConfig fields comprise a serving cell identifier (ID) list associated with a corresponding PCell and SCell.

Example 45 is a computer-readable medium comprising instructions that, when executed by one or more processors of a User Equipment (UE), cause the UE to: decode an RRCConnectionReconfiguration communication from a base station, the RRCConnectionReconfiguration communication comprising a measurement gap configuration per component carrier-list (MeasGapConfigPerCC-list) information element, the MeasGapConfigPerCC-list information element comprising one or more MeasGapConfig fields; set up a measurement gap configuration indicated by the one or more MeasGapConfig fields; and encode signaling for measurement reporting in accordance with the one or more MeasGapConfig fields of the RRCConnectionReconfiguration communication.

In Example 46, the subject matter of Example 45 optionally includes wherein the one or more MeasGapConfig fields further comprise a gap offset (gapOffset) which comprises at least three values, each value of the gapOffset associated with different gap pattern settings.

In Example 47, the subject matter of any one or more of Examples 45-46 optionally include wherein the one or more MeasGapConfig fields comprise a serving cell identifier (ID) list associated with a corresponding PCell and SCell.

Example 48 is an apparatus of a base station, the apparatus comprising: processing circuitry configured to: generate an RRCConnectionReconfiguration communication for a user equipment (UE), the RRCConnectionReconfiguration communication comprising a measurement gap configuration per component carrier-list (MeasGapConfigPerCC-list) information element, the MeasGapConfigPerCC-list information element comprising one or more MeasGapConfig fields; and encode the RRCConnectionReconfiguration communication for transmission to the UE from the base station; and an interface coupled to the processing circuitry and configured for communication of the RRCConnectionReconfiguration communication from the base station to the UE.

In Example 49, the subject matter of Example 48 optionally includes wherein the processing circuitry is further configured to decode signaling for measurement reporting in accordance with the one or more MeasGapConfig fields and the RRCConnectionReconfiguration communication; and wherein the interface is further configured to receive the signaling for the measurement reporting.

In Example 50, the subject matter of any one or more of Examples 48-49 optionally include wherein the one or more MeasGapConfig fields of the set of fields comprise a serving cell identifier (ID) list associated with a corresponding PCell and SCell.

Example 51 is a computer-readable medium comprising instructions that, when executed by one or more processors of a base station, cause the base station to: generate an RRCConnectionReconfiguration communication for a user equipment (UE), the RRCConnectionReconfiguration communication comprising a measurement gap configuration per component carrier-list (MeasGapConfigPerCC-list) information element, the MeasGapConfigPerCC-list information element comprising one or more

MeasGapConfig fields; encode the RRCConnectionReconfiguration communication for transmission to the UE from the base station; and decode signaling for measurement reporting in accordance with the one or more MeasGapConfig fields and the RRCConnectionReconfiguration communication.

In Example 52, the subject matter of Example 51 optionally includes wherein the processing circuitry is further configured to decode signaling for measurement reporting in accordance with the one or more MeasGapConfig fields and the RRCConnectionReconfiguration communication; and wherein the interface is further configured to receive the signaling for the measurement reporting.

In Example 53, the subject matter of any one or more of Examples 51-52 optionally include wherein the one or more MeasGapConfig fields of the set of fields comprise a serving cell identifier (ID) list associated with a corresponding PCell and SCell.

Example 54 is an apparatus of a user equipment (UE), the apparatus comprising: means for storing an RRCConnectionReconfiguration communication from a base station, the RRCConnectionReconfiguration communication comprising a measure gap configuration (MeasGapConfig) information element, the MeasGapConfig information element comprising a gap offset field (gapOffset) indicating one or more gap offset gap patterns, the one or more gap offset gap patterns (gp) comprising at least a first network-controlled small-gap (ncsg) gap pattern (gp-ncsg); and means for decoding the RRCConnectionReconfiguration communication from the base station to identify the gapOffset field; and means for setting up a measurement gap configuration indicated by the MeasGapConfig information element in accordance with the gapOffset.

In Example 55, the subject matter of Example 54 optionally includes wherein the processing circuitry is configured to encode signaling for measurement reporting in accordance with the MeasGapConfig information element and gapOffset of the RRCConnectionReconfiguration communication.

In Example 56, the subject matter of any one or more of Examples 54-55 optionally include wherein the RRCConnectionReconfiguration communication further comprises a field for a per-component carrier gap indication request (perCCgapRequest) requesting measurement gap preferences of the UE per component carrier.

In Example 57, the subject matter of Example 56 optionally includes further comprising: means for decoding the RRCConnectionReconfiguration communication from the base station to identify the PerCCgapRequest; means for setting content of an RRCConnectionReconfigurationComplete message to include an indication of the measurement gap preferences of the UE per component carrier in response to the PerCCgapRequest; and means for initiating transmission of the RRCConnectionReconfigurationComplete message comprising the measurement gap preferences of the UE per component carrier to the base station.

In Example 58, the subject matter of any one or more of Examples 54-57 optionally include wherein the gapOffset comprises a first value indicating a per-component carrier measurement configuration.

In Example 59, the subject matter of any one or more of Examples 54-58 optionally include wherein the RRCConnectionReconfiguration communication comprises a measurement gap configuration per component carrier-list (MeasGapConfigPerCC-list) information element, the MeasGapConfigPerCC-list information element comprising at least the MeasGapConfig information element.

In Example 60, the subject matter of any one or more of Examples 54-59 optionally include further comprising: means for decoding a UE capability enquiry from the base station; and means for communicating a support-NCSG-r14 response indicating that the UE supports NCSG measurement gap operation in response to the UE capability enquiry.

In Example 61, the subject matter of Example 60 optionally includes further comprising: means for processing an RRC Setup with the base station prior to receipt of the UE capability enquiry; wherein the UE further communicates a list of supported carrier aggregation band combinations and non-carrier aggregation bands in response to the UE capability enquiry prior to processing of the RRCConnectionReconfiguration communication; and wherein the RRCConnectionReconfiguration communication from the base station is generated at least in part based on the list of supported carrier aggregation band combinations from the UE.

In Example 62, the subject matter of Example 61 optionally includes further comprising: radio frequency circuitry coupled to the processing circuitry; and one or more antennas coupled to the radio frequency circuitry and configured to receive the RRCConnectionReconfiguration communication from the base station.

Example 63 is a method for measurement gap configuration operations in a communication system, the method comprising: decoding an RRCConnectionReconfiguration communication from a base station to identify a gap offset field, the RRCConnectionReconfiguration communication comprising a measure gap configuration (MeasGapConfig) information element, the MeasGapConfig information element comprising the gap offset field (gapOffset) indicating one or more gap offset gap patterns, the one or more gap offset gap patterns (gp) comprising at least a first network-controlled small-gap (ncsg) gap pattern (gp-ncsg); setting up a measurement gap configuration indicated by the MeasGapConfig information element in accordance with the gapOffset; and encoding signaling for measurement reporting in accordance with the MeasGapConfig information element and gapOffset of the RRCConnectionReconfiguration communication.

In Example 64, the subject matter of Example 63 optionally includes wherein the gapOffset comprises at least three values, each value of the gapOffset associated with different gap pattern settings; wherein the gapOffset comprises a gp2 value corresponding to an MGRP value of 40 ms and a 3 ms gap duration for measurement; and wherein the MeasGapConfig information element comprises a serving cell identifier (ID) list associated with a corresponding PCell and SCell.

In Example 65, the subject matter of any one or more of Examples 63-64 optionally include further comprising: decode a UE capability enquiry from the base station; in response to the UE capability enquiry, communicate a support-NCSG-r14 response indicating that the UE supports NCSG measurement gap operation; and process an RRC Setup with the base station prior to receipt of the UE capability enquiry; wherein the UE further communicates a list of supported carrier aggregation band combinations and non-carrier aggregation bands in response to the UE capability enquiry prior to processing of the RRCConnectionReconfiguration communication; and wherein the RRCConnectionReconfiguration communication from the base station is generated at least in part based on the list of supported carrier aggregation band combinations from the UE.

Example 66 is an apparatus of a base station, the apparatus comprising: means for generating an RRCConnectionReconfiguration communication for a user equipment (UE), the RRCConnectionReconfiguration communication comprising a measure gap configuration (MeasGapConfig) information element, the MeasGapConfig information element comprising a gap offset field (gapOffset) indicating one or more gap offset gap patterns, the one or more gap offset gap patterns (gp) comprising at least a first network-controlled small-gap (ncsg) gap pattern (gp-ncsg); means for encoding the RRCConnectionReconfiguration communication for transmission to the UE from the base station; and means for decoding signaling for measurement reporting in accordance with the MeasGapConfig information element and gapOffset of the RRCConnectionReconfiguration communication.

In Example 67, the subject matter of Example 66 optionally includes further comprising: means for transmitting the RRCConnectionReconfiguration communication; and means for receiving the signaling for the measurement reporting.

In Example 68, the subject matter of any one or more of Examples 66-67 optionally include wherein the gapOffset comprises a first value indicating a per-component carrier measurement configuration.

In Example 69, the subject matter of any one or more of Examples 66-68 optionally include wherein the RRCConnectionReconfiguration communication comprises a measurement gap configuration per component carrier-list (MeasGapConfigPerCC-list) information element, the MeasGapConfigPerCC-list information element comprising at least the MeasGapConfig information element.

Example 70 is a method performed by a base station for measurement gap operations in a communication system, the method comprising: generating an RRCConnectionReconfiguration communication for a user equipment (UE), the RRCConnectionReconfiguration communication comprising a measure gap configuration (MeasGapConfig) information element, the MeasGapConfig information element comprising a gap offset field (gapOffset) indicating one or more gap offset gap patterns, the one or more gap offset gap patterns (gp) comprising at least a first network-controlled small-gap (ncsg) gap pattern (gp-ncsg); encoding the RRCConnectionReconfiguration communication for transmission to the UE from the base station; and decoding signaling for measurement reporting in accordance with the MeasGapConfig information element and gapOffset of the RRCConnectionReconfiguration communication.

In Example 71, the subject matter of Example 70 optionally includes wherein the gapOffset comprises at least three values, each value of the gapOffset associated with different gap pattern settings.

In Example 72, the subject matter of any one or more of Examples 70-71 optionally include wherein the MeasGapConfig information element comprises a serving cell identifier (ID) list associated with a corresponding PCell and SCell.

Example 73 is an apparatus of a user equipment (UE), the apparatus comprising: means for storing an RRCConnectionReconfiguration communication from a base station, the RRCConnectionReconfiguration communication comprising a measurement gap configuration per component carrier-list (MeasGapConfigPerCC-list) information element, the MeasGapConfigPerCC-list information element comprising one or more MeasGapConfig fields; means for decoding the RRCConnectionReconfiguration communication from the base station to identify the one or more MeasGapConfig fields; and means for setting up a measurement gap configuration indicated by the one or more MeasGapConfig fields.

In Example 74, the subject matter of Example 73 optionally includes further comprising: means for communicating, in response to the UE capability enquiry, a support-perCCGap response indicating that the UE supports per-component carrier measurement gap operation.

In Example 75, the subject matter of any one or more of Examples 73-74 optionally include further comprising: means for encoding signaling for measurement reporting in accordance with the one or more MeasGapConfig fields of the RRCConnectionReconfiguration communication.

In Example 76, the subject matter of any one or more of Examples 73-75 optionally include wherein the one or more MeasGapConfig fields comprise a serving cell identifier (ID) list associated with a corresponding PCell and SCell.

Example 77 is a processor implemented method for measurement gap operations at a User Equipment (UE), the method comprising: decoding an RRCConnectionReconfiguration communication from a base station, the RRCConnectionReconfiguration communication comprising a measurement gap configuration per component carrier-list (MeasGapConfigPerCC-list) information element, the MeasGapConfigPerCC-list information element comprising one or more MeasGapConfig fields; setting up a measurement gap configuration indicated by the one or more MeasGapConfig fields; and encoding signaling for measurement reporting in accordance with the one or more MeasGapConfig fields of the RRCConnectionReconfiguration communication.

In Example 78, the subject matter of Example 77 optionally includes wherein the one or more MeasGapConfig fields further comprise a gap offset (gapOffset) which comprises at least three values, each value of the gapOffset associated with different gap pattern settings.

In Example 79, the subject matter of any one or more of Examples 77-78 optionally include wherein the one or more MeasGapConfig fields comprise a serving cell identifier (ID) list associated with a corresponding PCell and SCell.

Example 80 is an apparatus of a base station, the apparatus comprising: means for generating an RRCConnectionReconfiguration communication for a user equipment (UE), the RRCConnectionReconfiguration communication comprising a measurement gap configuration per component carrier-list (MeasGapConfigPerCC-list) information element, the MeasGapConfigPerCC-list information element comprising one or more MeasGapConfig fields; and means for encoding the RRCConnectionReconfiguration communication for transmission to the UE from the base station; and means for communicating the RRCConnectionReconfiguration communication from the base station to the UE.

In Example 81, the subject matter of Example 80 optionally includes wherein the processing circuitry is further configured to decode signaling for measurement reporting in accordance with the one or more MeasGapConfig fields and the RRCConnectionReconfiguration communication; and wherein the interface is further configured to receive the signaling for the measurement reporting.

In Example 82, the subject matter of any one or more of Examples 80-81 optionally include wherein the one or more MeasGapConfig fields of the set of fields comprise a serving cell identifier (ID) list associated with a corresponding PCell and SCell.

Example 83 is a processor implemented method for measurement gap operations at a base station device, the method comprising: generating an RRCConnectionReconfiguration communication for a user equipment (UE), the RRCConnectionReconfiguration communication comprising a measurement gap configuration per component carrier-list (MeasGapConfigPerCC-list) information element, the MeasGapConfigPerCC-list information element comprising one or more MeasGapConfig fields; encoding the RRCConnectionReconfiguration communication for transmission to the UE from the base station; and decoding signaling for measurement reporting in accordance with the one or more MeasGapConfig fields and the RRCConnectionReconfiguration communication.

In Example 84, the subject matter of Example 83 optionally includes further comprising: decoding signaling for measurement reporting in accordance with the one or more MeasGapConfig fields and the RRCConnectionReconfiguration communication; and wherein the interface is further configured to receive the signaling for the measurement reporting.

In Example 85, the subject matter of any one or more of Examples 83-84 optionally include wherein the one or more MeasGapConfig fields of the set of fields comprise a serving cell identifier (ID) list associated with a corresponding PCell and SCell.

In Example 86, the subject matter of any one or more of Examples 62-85 optionally include wherein the gapOffset comprises a gp4 value corresponding to a per-component carrier gap configuration.

In Example 87, the subject matter of any one or more of Examples 54-86 optionally include wherein the gapOffset comprises at least three values, each value of the gapOffset associated with different gap pattern settings.

In Example 88, the subject matter of any one or more of Examples 54-87 optionally include wherein the MeasGapConfig information element comprises a serving cell identifier (ID) list associated with a corresponding PCell and SCell.

In Example 89, the subject matter of any one or more of Examples 60-88 optionally include wherein the gapOffset comprises a gp2 value corresponding to a measurement gap repetition period (MGRP) value of 40 ms and a 3 ms gap duration for measurement.

In Example 90, the subject matter of any one or more of Examples 61-89 optionally include wherein the gapOffset comprises a gp3 value corresponding to an MGRP value of 80 ms and a 3 ms gap duration for measurement.

The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

In addition to the above example embodiments, any combination of operations or elements described above may be integrated into various embodiments described herein. Additionally, other example embodiments may include any examples described above with the individual operations or device elements repeated or ordered with intervening elements or operations in any functional order.

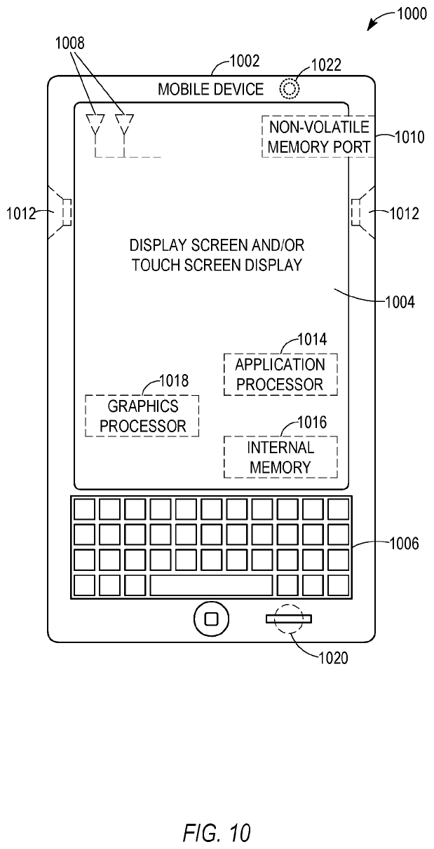

FIG. 10 shows an example UE 1000. The UE 1000 may be an implementation of the UE 102, 201, 310, 410, or 510, or any device described herein. The UE 1000 can include one or more antennas 1008 configured to communicate with a transmission station, such as a base station, an eNB, or another type of wireless WAN (WWAN) access point. The UE 1000 can communicate using separate antennas for each wireless communication standard or shared antennas for multiple wireless communication standards. The UE 1000 can communicate in a wireless local area network (WLAN), a wireless personal area network (WPAN), and/or a WWAN.

FIG. 10 also shows a microphone 1020 and one or more speakers 1012 that can be used for audio input and output to and from the UE 1000. As a headed device, the UE 1000 includes one or more interfaces for a UI. The UE 1000 particularly includes a display screen 1004, which can be a liquid crystal display (LCD) screen or another type of display screen such as an organic light-emitting diode (OLED) display. The display screen 1004 can be configured as a touch screen. The touch screen can use capacitive, resistive, or another type of touch-screen technology. An application processor 1014 and a graphics processor 1018 can be coupled to an internal memory 1016 to provide processing and display capabilities. A non-volatile memory port 1010 can also be used to provide data input/output (I/O) options to a user. The non-volatile memory port 1010 can also be used to expand the memory capabilities of the UE 1000. A keyboard 1006 can be integrated with the UE 1000 or wirelessly connected to the UE 1000 to provide additional user input. A virtual keyboard can also be provided using the touch screen. A camera 1022 located on the front (display screen 1004) side or the rear side of the UE 1000 can also be integrated into a housing 1002 of the UE 1000.

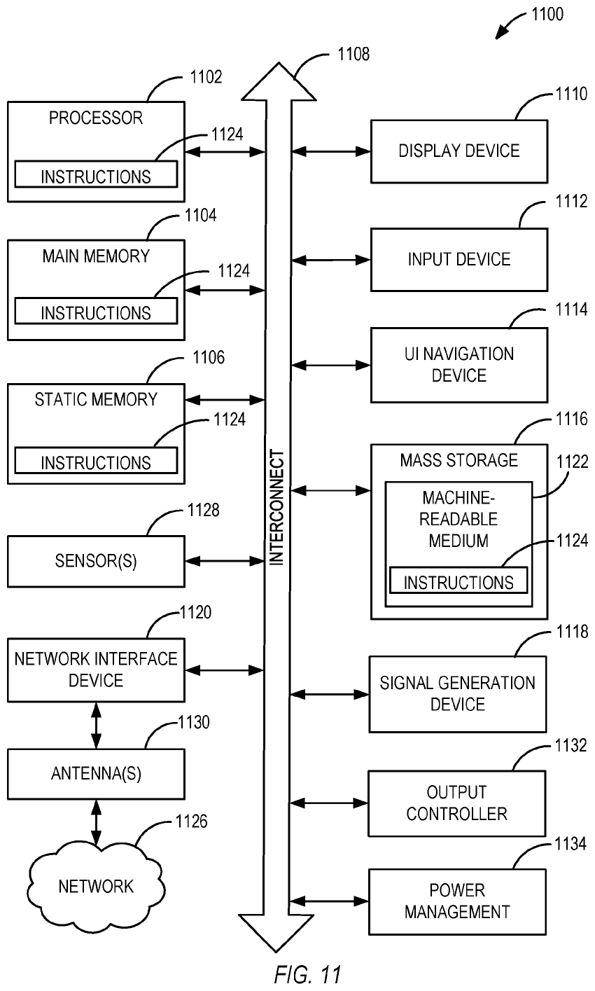

FIG. 11 is a block diagram illustrating an example computer system machine 1100 upon which any one or more of the methodologies herein discussed can be performed, and which may be used to implement the eNB 104, the UE 102, or any other device described herein. In various alternative embodiments, the computer system machine 1100 operates as a standalone device or can be connected (e.g., networked) to other machines. In a networked deployment, the computer system machine 1100 can operate in the capacity of either a server or a client machine in server-client network environments, or it can act as a peer machine in peer-to-peer (or distributed) network environments. The computer system machine 1100 can be a personal computer (PC) that may or may not be portable (e.g., a notebook or a netbook), a tablet, a set-top box (STB), a gaming console, a Personal Digital Assistant (PDA), a mobile telephone or smartphone, a web appliance, a network router, a network switch, a network bridge, or any machine capable of executing instructions (sequential or otherwise) that specify actions to be taken by that machine. Further, while only a single computer system machine 1100 is illustrated, the term “machine” shall also be taken to include any collection of machines that individually or jointly execute a set (or multiple sets) of instructions to perform any one or more of the methodologies discussed herein.

The example computer system machine 1100 includes a processor 1102 (e.g., a central processing unit (CPU), a graphics processing unit (GPU), or both), a main memory 1104, and a static memory 1106, which communicate with each other via an interconnect 1108 (e.g., a link, a bus, etc.). The computer system machine 1100 can further include a video display device 1110, an alphanumeric input device 1112 (e.g., a keyboard), and a user interface (UI) navigation device 1114 (e.g., a mouse). In one embodiment, the video display device 1110, alphanumeric input device 1112, and UI navigation device 1114 are a touch-screen display. The computer system machine 1100 can additionally include a mass storage device 1116 (e.g., a drive unit), a signal generation device 1118 (e.g., a speaker), an output controller 1132, a power management controller 1134, a network interface device 1120 (which can include or operably communicate with one or more antennas 1130, transceivers, or other wireless communications hardware), and one or more sensors 1128, such as a Global Positioning System (GPS) sensor, compass, location sensor, accelerometer, or other sensor.

The mass storage device 1116 includes a machine-readable medium 1122 on which is stored one or more sets of data structures and instructions 1124 (e.g., software) embodying or utilized by any one or more of the methodologies or functions described herein. The instructions 1124 can also reside, completely or at least partially, within the main memory 1104, static memory 1106, and/or processor 1102 during execution thereof by the computer system machine 1100, with the main memory 1104, the static memory 1106, and the processor 1102 also constituting machine-readable media.

While the machine-readable medium 1122 is illustrated in an example embodiment to be a single medium, the term “machine-readable medium” can include a single medium or multiple media (e.g., a centralized or distributed to database, and/or associated caches and servers) that store the one or more instructions 1124. The term “machine-readable medium” shall also be taken to include any tangible medium that is capable of storing, encoding, or carrying instructions (e.g., the instructions 1124) for execution by the machine and that cause the machine to perform any one or more of the methodologies of the present disclosure, or that is capable of storing, encoding, or carrying data structures utilized by or associated with such instructions.

The instructions 1124 can further be transmitted or received over a communications network 1126 using a transmission medium via the network interface device 1120 utilizing any one of a number of well-known transfer protocols (e.g., hypertext transfer protocol (HTTP)). The term “transmission medium” shall be taken to include any medium that is capable of storing, encoding, or carrying instructions for execution by the machine, and includes digital or analog communications signals or other intangible media to facilitate communication of such software.

Various techniques, or certain aspects or portions thereof, may take the form of program code (e.g., the instructions 1124) embodied in tangible media, such as floppy diskettes, CD-ROMs, hard drives, non-transitory computer-readable storage media, or any other machine-readable storage medium wherein, when the program code is loaded into and executed by a machine, such as a computer, the machine becomes an apparatus for practicing the various techniques. In the case of program code execution on programmable computers, the computer may include a processor, a storage medium readable by the processor (including volatile and non-volatile memory and/or storage elements), at least one input device, and at least one output device. The volatile and non-volatile memory and/or storage elements may be a Random Access Memory (RAM), Erasable Programmable Read-Only Memory (EPROM), flash drive, optical drive, magnetic hard drive, or other medium for storing electronic data. The eNB and UE may also include a transceiver module, a counter module, a processing module, and/or a clock module or timer module. One or more programs that may implement or utilize the various techniques described herein may use an application programming interface (API), reusable controls, and the like. Such programs may be implemented in a high-level procedural or object-oriented programming language to communicate with a computer system.

However, the program(s) may be implemented in assembly or machine language, if desired. In any case, the language may be a compiled or interpreted language, and combined with hardware implementations.

Various embodiments may use 3GPP LTE/LTE-A, Institute of Electrical and Electronics Engineers (IEEE) 1002.11, and Bluetooth communication standards. Various alternative embodiments may use a variety of other WWAN, WLAN, and WPAN protocols and standards in connection with the techniques described herein. These standards include, but are not limited to, other standards from 3GPP (e.g., HSPA+, UMTS), IEEE 1102.16 (e.g., 1102.16p), or Bluetooth (e.g., Bluetooth 11.0, or like standards defined by the Bluetooth Special Interest Group) standards families. Other applicable network configurations can be included within the scope of the presently described communication networks. It will be understood that communications on such communication networks can be facilitated using any number of personal area networks (PANs), local area networks (LANs), and WANs, using any combination of wired or wireless transmission mediums.

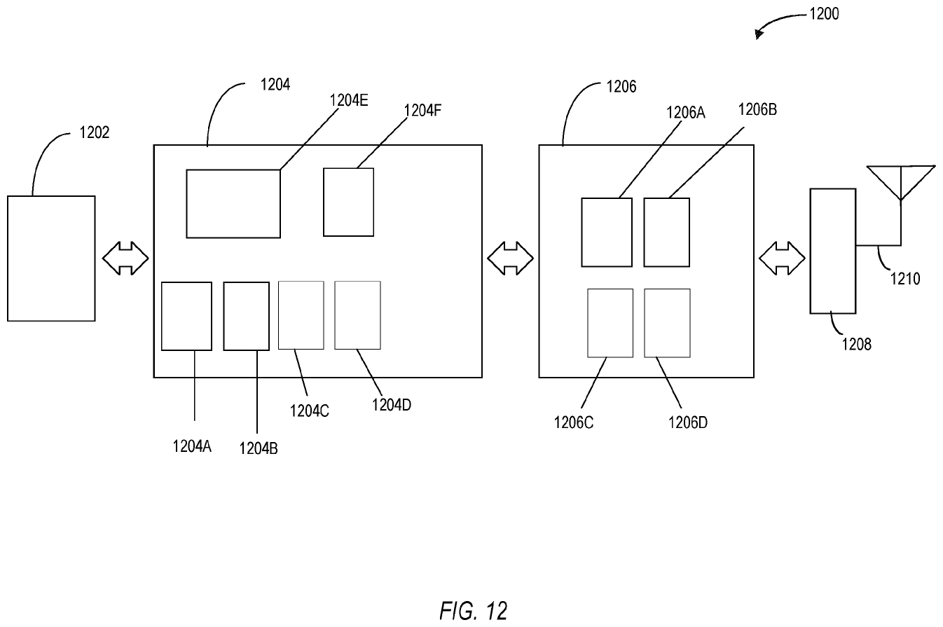

Embodiments described herein may be implemented into a system using any suitably configured hardware and/or software. FIG. 12 illustrates components of a UE 1200 in accordance with some embodiments. At least some of the components shown may be used in the UE 102 (or eNB 104) shown in FIG. 1. The UE 1200 and other components may be configured to use the synchronization signals as described herein. The UE 1200 may be one of the UEs 102 shown in FIG. 1 and may be a stationary, non-mobile device or may be a mobile device. In some embodiments, the UE 1200 may include application circuitry 1202, baseband circuitry 1204, RF circuitry 1206, FEM circuitry 1208, and one or more antennas 1210, coupled together at least as shown. At least some of the baseband circuitry 1204, RF circuitry 1206, and FEM circuitry 1208 may form a transceiver. In some embodiments, other network elements, such as the eNB 104, may contain some or all of the components shown in FIG. 12. Other of the network elements may contain an interface, such as an S1 interface, to communicate with the eNB 104 (or any base station) over a wired connection regarding the UE 1200.

The application circuitry 1202 may include one or more application processors. For example, the application circuitry 1202 may include circuitry such as, but not limited to, one or more single-core or multi-core processors. The processor(s) may include any combination of general-purpose processors and dedicated processors (e.g., graphics processors, application processors, etc.). The processors may be coupled with and/or may include memory/storage and may be configured to execute instructions stored in the memory/storage to enable various applications and/or operating systems to run on the UE 1200.

The baseband circuitry 1204 may include circuitry such as, but not limited to, one or more single-core or multi-core processors. The baseband circuitry 1204 may include one or more baseband processors and/or control logic to process baseband signals received from a receive signal path of the RF circuitry 1206 and to generate baseband signals for a transmit signal path of the RF circuitry 1206. The baseband circuitry 1204 may interface with the application circuitry 1202 for generation and processing of the baseband signals and for controlling operations of the RF circuitry 1206. For example, in some embodiments, the baseband circuitry 1204 may include a second generation (2G) baseband processor 1204a, third generation (3G) baseband processor 1204b, fourth generation (4G) baseband processor 1204c, and/or other baseband processor(s) 1204d for other existing generations, generations in development, or generations to be developed in the future (e.g., fifth generation (5G), etc.). The baseband circuitry 1204 (e.g., one or more of the baseband processors 1204a-d) may handle various radio control functions that enable communication with one or more radio networks via the RF circuitry 1206. The radio control functions may include, but are not limited to, signal modulation/demodulation, encoding/decoding, radio frequency shifting, and so forth. In some embodiments, modulation/demodulation circuitry of the baseband circuitry 1204 may include fast Fourier transform (FFT), precoding, and/or constellation mapping/demapping functionality. In some embodiments, encoding/decoding circuitry of the baseband circuitry 1204 may include convolution, tail-biting convolution, turbo, Viterbi, and/or Low-Density Parity Check (LDPC) encoder/decoder functionality. Embodiments of modulation/demodulation and encoder/decoder functionality are not limited to these examples and may include other suitable functionality in other embodiments.

In some embodiments, the baseband circuitry 1204 may include elements of a protocol stack such as, for example, elements of an EUTRAN protocol including, for example, physical (PHY), media access control (MAC), radio link control (RLC), packet data convergence protocol (PDCP), and/or radio resource control (RRC) elements. A central processing unit (CPU) 1204e of the baseband circuitry 1204 may be configured to run elements of the protocol stack for signaling of the PHY, MAC, RLC, PDCP, and/or RRC layers. In some embodiments, the baseband circuitry 1204 may include one or more audio digital signal processors (DSPs) 1204f. The audio DSP(s) 1204f may be or include elements for compression/decompression and echo cancellation and may include other suitable processing elements in other embodiments. Components of the baseband circuitry 1204 may be suitably combined in a single chip or a single chipset, or disposed on a same circuit board, in some embodiments. In some embodiments, some or all of the constituent components of the baseband circuitry 1204 and the application circuitry 1202 may be implemented together, such as, for example, on a system on a chip (SOC).

In some embodiments, the baseband circuitry 1204 may provide for communication compatible with one or more radio technologies. For example, in some embodiments, the baseband circuitry 1204 may support communication with the EUTRAN and/or other wireless metropolitan area networks (WMAN), a WLAN, or a WPAN. Embodiments in which the baseband circuitry 1204 is configured to support radio communications of more than one wireless protocol may be referred to as multi-mode baseband circuitry. In some embodiments, the UE 1200 can be configured to operate in accordance with communication standards or other protocols or standards, including IEEE 1002.16 wireless technology (WiMax®), IEEE 1002.11 wireless technology (Wi-Fi®) including IEEE 1002.11ad, which operates in the 110 GHz millimeter wave spectrum, or various other wireless technologies such as global system for mobile communications (GSM), enhanced data rates for GSM evolution (EDGE), GSM EDGE radio access network (GERAN), universal mobile telecommunications system (UMTS), UMTS terrestrial radio access network (U IRAN), or other 2G, 3G, 4G, 5G, and the like technologies either already developed or to be developed.

The RF circuitry 1206 may enable communication with wireless networks using modulated electromagnetic radiation through a non-solid medium. In various embodiments, the RF circuitry 1206 may include switches, filters, amplifiers, and the like to facilitate the communication with the wireless network. The RF circuitry 1206 may include a receive signal path which may include circuitry to down-convert RF signals received from the FEM circuitry 1208 and provide baseband signals to the baseband circuitry 1204. The RF circuitry 1206 may also include a transmit signal path which may include circuitry to up-convert baseband signals provided by the baseband circuitry 1204 and provide RF output signals to the FEM circuitry 1208 for transmission.

In some embodiments, the RF circuitry 1206 may include a receive signal path and a transmit signal path. The receive signal path of the RF circuitry 1206 may include mixer circuitry 1206a, amplifier circuitry 1206b, and filter circuitry 1206c. The transmit signal path of the RF circuitry 1206 may include the filter circuitry 1206c and the mixer circuitry 1206a. The RF circuitry 1206 may also include synthesizer circuitry 1206d for synthesizing a frequency for use by the mixer circuitry 1206a of the receive signal path and the transmit signal path. In some embodiments, the mixer circuitry 1206a of the receive signal path may be configured to down-convert RF signals received from the FEM circuitry 1208 based on the synthesized frequency provided by the synthesizer circuitry 1206d. The amplifier circuitry 1206b may be configured to amplify the down-converted signals, and the filter circuitry 1206c may be a low-pass filter (LPF) or band-pass filter (BPF) configured to remove unwanted signals from the down-converted signals to generate output baseband signals. Output baseband signals may be provided to the baseband circuitry 1204 for further processing. In some embodiments, the output baseband signals may be zero-frequency baseband signals, although this is not a requirement. In some embodiments, the mixer circuitry 1206a of the receive signal path may comprise passive mixers, although the scope of the embodiments is not limited in this respect.

In some embodiments, the mixer circuitry 1206a of the transmit signal path may be configured to up-convert input baseband signals based on the synthesized frequency provided by the synthesizer circuitry 1206d to generate RF output signals for the FEM circuitry 1208. The baseband signals may be provided by the baseband circuitry 1204 and may be filtered by the filter circuitry 1206c. The filter circuitry 1206c may include an LPF, although the scope of the embodiments is not limited in this respect.

In some embodiments, the mixer circuitry 1206a of the receive signal path and the mixer circuitry 1206a of the transmit signal path may include two or more mixers and may be arranged for quadrature downconversion and/or upconversion, respectively. In some embodiments, the mixer circuitry 1206a of the receive signal path and the mixer circuitry 1206a of the transmit signal path may include two or more mixers and may be arranged for image rejection (e.g., Hartley image rejection). In some embodiments, the mixer circuitry 1206a of the receive signal path and the mixer circuitry 1206a of the transmit signal path may be arranged for direct downconversion and/or direct upconversion, respectively. In some embodiments, the mixer circuitry 1206a of the receive signal path and the mixer circuitry 1206a of the transmit signal path may be configured for super-heterodyne operation.

In some embodiments, the output baseband signals and the input baseband signals may be analog baseband signals, although the scope of the embodiments is not limited in this respect. In some alternate embodiments, the output baseband signals and the input baseband signals may be digital baseband signals. In these alternate embodiments, the RF circuitry 1206 may include analog-to-digital converter (ADC) and digital-to-analog converter (DAC) circuitry and the baseband circuitry 1204 may include a digital baseband interface to communicate with the RF circuitry 1206.

In some dual-mode embodiments, a separate radio integrated circuit (IC) circuitry may be provided for processing signals for each spectrum, although the scope of the embodiments is not limited in this respect.

In some embodiments, the synthesizer circuitry 1206d may be a fractional-N synthesizer or a fractional N/N+1 synthesizer, although the scope of the embodiments is not limited in this respect, as other types of frequency synthesizers may be suitable. For example, the synthesizer circuitry 1206d may be a delta-sigma synthesizer, a frequency multiplier, or a synthesizer comprising a phase-locked loop with a frequency divider.

The synthesizer circuitry 1206d may be configured to synthesize an output frequency for use by the mixer circuitry 1206a of the RF circuitry 1206 based on a frequency input and a divider control input. In some embodiments, the synthesizer circuitry 1206d may be a fractional N/N+1 synthesizer.

In some embodiments, frequency input may be provided by a voltage-controlled oscillator (VCO), although that is not a requirement. Divider control input may be provided by either the baseband circuitry 1204 or the application circuitry 1202 depending on the desired output frequency. In some embodiments, a divider control input (e.g., N) may be determined from a look-up table based on a channel indicated by the application circuitry 1202.

The synthesizer circuitry 1206d of the RF circuitry 1206 may include a divider, a delay-locked loop (DLL), a multiplexer, and a phase accumulator. In some embodiments, the divider may be a dual modulus divider (DMD) and the phase accumulator may be a digital phase accumulator (DPA). In some embodiments, the DMD may be configured to divide the input signal by either N or N+1 (e.g., based on a carry out) to provide a fractional division ratio. In some example embodiments, the DLL may include a set of cascaded, tunable, delay elements, a phase detector, a charge pump, and a D-type flip-flop. In these embodiments, the delay elements may be configured to break a VCO period up into Nd equal packets of phase, where Nd is the number of delay elements in the delay line. In this way, the DLL provides negative feedback to help ensure that the total delay through the delay line is one VCO cycle.

In some embodiments, the synthesizer circuitry 1206d may be configured to generate a carrier frequency as the output frequency, while in other embodiments, the output frequency may be a multiple of the carrier frequency (e.g., twice the carrier frequency, four times the carrier frequency) and used in conjunction with quadrature generator and divider circuitry to generate multiple signals at the carrier frequency with multiple different phases with respect to each other. In some embodiments, the output frequency may be a LO frequency (fLo). In some embodiments, the RF circuitry 1206 may include an IQ/polar converter.

The FEM circuitry 1208 may include a receive signal path, which may include circuitry configured to operate on RF signals received from the one or more antennas 1210, amplify the received signals, and provide the amplified versions of the received signals to the RF circuitry 1206 for further processing. The FEM circuitry 1208 may also include a transmit signal path, which may include circuitry configured to amplify signals for transmission provided by the RF circuitry 1206 for transmission by one or more of the one or more antennas 1210.

In some embodiments, the FEM circuitry 1208 may include a Tx/Rx switch to switch between transmit mode and receive mode operation. The FEM circuitry 1208 may include a receive signal path and a transmit signal path. The receive signal path of the FEM circuitry 1208 may include a low-noise amplifier (LNA) to amplify received RF signals and provide the amplified received RF signals as an output (e.g., to the RF circuitry 1206). The transmit signal path of the FEM circuitry 1208 may include a power amplifier (PA) to amplify input RF signals (e.g., provided by the RF circuitry 1206), and one or more filters to generate RF signals for subsequent transmission (e.g., by one or more of the one or more antennas 1210).

In some embodiments, the UE 1200 may include additional elements such as, for example, a memory/storage, display, camera, sensor, and/or I/O interface as described in more detail below. In some embodiments, the UE 1200 described herein may be part of a portable wireless communication device, such as a PDA, a laptop or portable computer with wireless communication capability, a web tablet, a wireless telephone, a smartphone, a wireless headset, a pager, an instant messaging device, a digital camera, an access point, a television, a medical device (e.g., a heart rate monitor, a blood pressure monitor, etc.), or another device that may receive and/or transmit information wirelessly. In some embodiments, the UE 1200 may include one or more user interfaces designed to enable user interaction with the system and/or peripheral component interfaces designed to enable peripheral component interaction with the system. For example, the UE 1200 may include one or more of a keyboard, a keypad, a touchpad, a display, a sensor, a non-volatile memory port, a universal serial bus (USB) port, an audio jack, a power supply interface, one or more antennas, a graphics processor, an application processor, a speaker, a microphone, and other I/O components. The display may be an LCD or light-emitting diode (LED) screen including a touch screen. The sensor may include a gyro sensor, an accelerometer, a proximity sensor, an ambient light sensor, and a positioning unit. The positioning unit may communicate with components of a positioning network, e.g., a GPS satellite.

The antennas 1210 may comprise one or more directional or omnidirectional antennas, including, for example, dipole antennas, monopole antennas, patch antennas, loop antennas, microstrip antennas, or other types of antennas suitable for transmission of RF signals. In some multiple-input multiple-output (MIMO) embodiments, the antennas 1210 may be effectively separated to benefit from spatial diversity and the different channel characteristics that may result.

Although the UE 1200 is illustrated as having several separate functional elements, two or more of the functional elements may be combined, and one or more of the functional elements may be implemented by combinations of software-configured elements, such as processing elements including DSPs, and/or other hardware elements. For example, some elements may comprise one or more microprocessors, DSPs, field-programmable gate arrays (FPGAs), application-specific integrated circuits (ASICs), radio-frequency integrated circuits (RFICs), and combinations of various hardware and logic circuitry for performing at least the functions described herein. In some embodiments, the functional elements may refer to one or more processes operating on one or more processing elements.

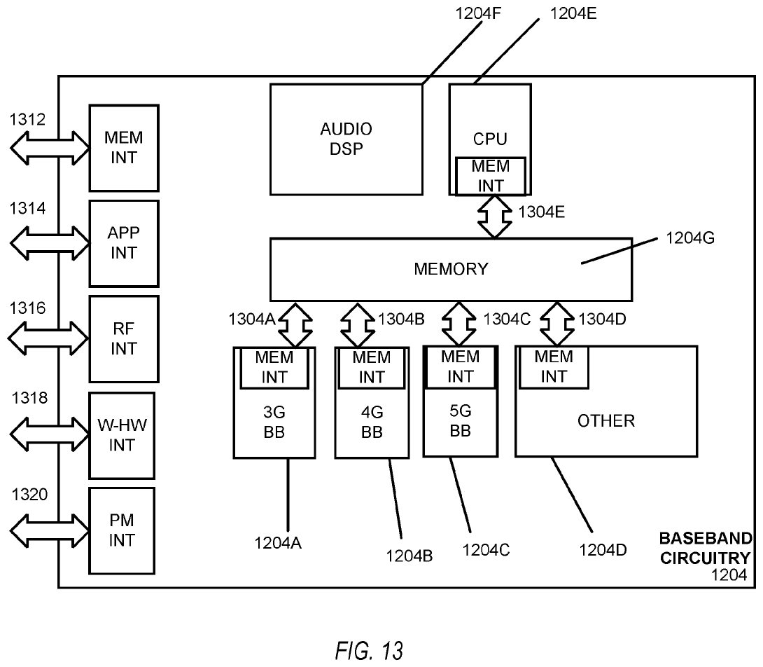

FIG. 13 illustrates example interfaces of baseband circuitry in accordance with some embodiments. As discussed above, the baseband circuitry 1204 of FIG. 12 may comprise processors 1204A-1204F and a memory 1204G utilized by said processors. Each of the processors 1204A-1204E may include a memory interface, 1304A-1304E, respectively, to send/receive data to/from the memory 1204G.

The baseband circuitry 1204 may further include one or more interfaces to communicatively couple to other circuitries/devices, such as a memory interface 1312 (e.g., an interface to send/receive data to/from memory external to the baseband circuitry 1204), an application circuitry interface 1314 (e.g., an interface to send/receive data to/from the application circuitry 1202 of FIG. 12), an RF circuitry interface 1316 (e.g., an interface to send/receive data to/from the RF circuitry 1206 of FIG. 12), a wireless hardware connectivity interface 1318 (e.g., an interface to send/receive data to/from Near Field Communication (NFC) components, Bluetooth® components (e.g., Bluetooth® Low Energy), Wi-Fi® components, and other communication components), and a power management interface 1320 (e.g., an interface to send/receive power or control signals to/from a PMC.

Examples, as described herein, may include, or may operate on, logic or a number of components, modules, or mechanisms. Modules are tangible entities (e.g., hardware) capable of performing specified operations and may be configured or arranged in a certain manner. In an example, circuits may be arranged (e.g., internally or with respect to external entities such as other circuits) in a specified manner as a module. In an example, the whole or part of one or more computer systems (e.g., a standalone, client, or server computer system) or one or more hardware processors may be configured by firmware or software (e.g., instructions, an application portion, or an application) as a module that operates to perform specified operations. In an example, the software may reside on a communication device-readable medium. In an example, the software, when executed by the underlying hardware of the module, causes the hardware to perform the specified operations.

Accordingly, the term “module” is understood to encompass a tangible entity, be that an entity that is physically constructed, specifically configured (e.g., hardwired), or temporarily (e.g., transitorily) configured (e.g., programmed) to operate in a specified manner or to perform part or all of any operation described herein. Considering examples in which modules are temporarily configured, each of the modules need not be instantiated at any one moment in time. For example, where the modules comprise a general-purpose hardware processor configured using software, the general-purpose hardware processor may be configured as respective different modules at different times. Software may accordingly configure a hardware processor, for example, to constitute a particular module at one instance of time and to constitute a different module at a different instance of time.

While the communication device-readable medium is illustrated as a single medium, the term “communication device-readable medium” may include a single medium or multiple media (e.g., a centralized or distributed database, and/or associated caches and servers) configured to store the one or more instructions.

The term “communication device-readable medium” may include any medium that is capable of storing, encoding, or carrying instructions for execution by the communication device and that cause the communication device to perform any one or more of the techniques of the present disclosure, or that is capable of storing, encoding, or carrying data structures used by or associated with such instructions. Non-limiting communication device-readable medium examples may include solid-state memories, and optical and magnetic media. Specific examples of communication device-readable media may include non-volatile memory, such as semiconductor memory devices (e.g., EPROM, Electrically Erasable Programmable Read-Only Memory (EEPROM)) and flash memory devices; magnetic disks, such as internal hard disks and removable disks; magneto-optical disks; RAM; and CD-ROM and DVD-ROM disks. In some examples, communication device-readable media may include non-transitory communication device-readable media. In some examples, communication device-readable media may include communication device-readable media that is not a transitory propagating signal.

The instructions may further be transmitted or received over a communications network using a transmission medium via a network interface device utilizing any one of a number of transfer protocols (e.g., frame relay, internet protocol (IP), transmission control protocol (TCP), user datagram protocol (UDP), HTTP, etc.). Example communications networks may include a LAN, a WAN, a packet data network (e.g., the Internet), mobile telephone networks (e.g., cellular networks), Plain Old Telephone Service (POTS) networks, wireless data networks (e.g., IEEE 1002.11 family of standards known as Wi-Fi®, IEEE 1002.16 family of standards known as WiMAX®), IEEE 1002.15.4 family of standards, an LTE family of standards, a Universal Mobile Telecommunications System (UMTS) family of standards, or peer-to-peer (P2P) networks, among others. In an example, the network interface device may include one or more physical jacks (e.g., Ethernet, coaxial, or phone jacks) or one or more antennas to connect to the communications network. In an example, the network interface device may include a plurality of antennas to wirelessly communicate using single-input multiple-output (SIMO), MIMO, or multiple-input single-output (MISO) techniques. In some examples, the network interface device may wirelessly communicate using Multiple-User MIMO techniques. The term “transmission medium” shall be taken to include any intangible medium that is capable of storing, encoding, or carrying instructions for execution by the communication device, and includes digital or analog communications signals or other intangible media to facilitate communication of such software.

Embodiments may be implemented in one or a combination of hardware, firmware, and software. Embodiments may also be implemented as instructions stored on a computer-readable storage device, which may be read and executed by at least one processor to perform the operations described herein. A computer-readable storage device may include any non-transitory mechanism for storing information in a form readable by a machine (e.g., a computer). For example, a computer-readable storage device may include read-only memory (ROM), RAM, magnetic disk storage media, optical storage media, flash-memory devices, and other storage devices and media. Some embodiments may include one or more processors and may be configured with instructions stored on a computer-readable storage device.

Although an embodiment has been described with reference to specific example embodiments, it will be evident that various modifications and changes may be made to these embodiments without departing from the broader scope of the present disclosure. Accordingly, the specification and drawings are to be regarded in an illustrative rather than a restrictive sense. The accompanying drawings that form a part hereof show, by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Such embodiments of the subject matter may be referred to herein, individually and/or collectively, by the term “embodiments” merely for convenience and without intending to voluntarily limit the scope of this application to any single inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In this document, the terms “including” and “in which” are used as the plain-English equivalents of the respective terms “comprising” and “wherein.” Also, in the following claims, the terms “including” and “comprising” are open-ended; that is, a system, UE, article, composition, formulation, or process that includes elements in addition to those listed after such a term in a claim is still deemed to fall within the scope of that claim. Moreover, in the following claims, the terms “first,” “second,” “third,” etc. are used merely as labels, and are not intended to impose numerical requirements on their objects.

The Abstract of the Disclosure is provided to comply with 37 C.F.R. § 1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separate embodiment.

1. An apparatus of a user equipment (UE), the apparatus comprising:
a memory configured to store an RRCConnectionReconfiguration communication from a base station, the RRCConnectionReconfiguration communication comprising a measure gap configuration (MeasGapConfig) information element, the MeasGapConfig information element comprising a gap offset field (gapOffset) indicating one or more gap offset gap patterns, the one or more gap offset gap patterns (gp) comprising at least a first network-controlled small-gap (ncsg) gap pattern (gp-ncsg); and
processing circuitry coupled to the memory and configured to:
decode the RRCConnectionReconfiguration communication from the base station to identify the gapOffset field; and
set up a measurement gap configuration indicated by the MeasGapConfig information element in accordance with the gapOffset.

2. The apparatus of claim 1 wherein the processing circuitry is configured to encode signaling for measurement reporting in accordance with the MeasGapConfig information element and gapOffset of the RRCConnectionReconfiguration communication.

3. The apparatus of claim 1 wherein the RRCConnectionReconfiguration communication further comprises a field for a per-component carrier gap indication request (perCCgapRequest) requesting measurement gap preferences of the UE per component carrier; and
wherein the processing circuitry is further configured to:
decode the RRCConnectionReconfiguration communication from the base station to identify the PerCCgapRequest;
set content of an RRCConnectionReconfigurationComplete message to include an indication of the measurement gap preferences of the UE per component carrier in response to the PerCCgapRequest; and
initiate transmission of the RRCConnectionReconfigurationComplete message comprising the measurement gap preferences of the UE per component carrier to the base station.

4. The apparatus of claim 1 wherein the gapOffset comprises a first value indicating a per-component carrier measurement configuration.

5. The apparatus of claim 1 wherein the RRCConnectionReconfiguration communication comprises a measurement gap configuration per component carrier-list (MeasGapConfigPerCC-list) information element, the MeasGapConfigPerCC-list information element comprising at least the MeasGapConfig information element.

6. The apparatus of claim 1 wherein the gapOffset comprises at least three values, each value of the gapOffset associated with different gap pattern settings.

7. The apparatus of claim 6 wherein the gapOffset comprises a gp2 value corresponding to a measurement gap repetition period (MGRP) value of 40 ms and a 3 ms gap duration for measurement.

8. The apparatus of claim 7 wherein the gapOffset comprises a gp3 value corresponding to an MGRP value of 80 ms and a 3 ms gap duration for measurement.

9. The apparatus of claim 8 wherein the gapOffset comprises a gp4 value corresponding to a per-component carrier gap configuration.

10. The apparatus of claim 1 wherein the MeasGapConfig information element comprises a serving cell identifier (ID) list associated with a corresponding PCell and SCell.

11. The apparatus of claim 1 wherein the processing circuitry is further configured to:
decode a UE capability enquiry from the base station; and
in response to the UE capability enquiry, communicate a support-NCSG-r14 response indicating that the UE supports NCSG measurement gap operation.

12. The apparatus of claim 11 wherein the processing circuitry is further configured to:
process an RRC Setup with the base station prior to receipt of the UE capability enquiry;
wherein the UE further communicates a list of supported carrier aggregation band combinations and non-carrier aggregation bands in response to the UE capability enquiry prior to processing of the RRCConnectionReconfiguration communication; and
wherein the RRCConnectionReconfiguration communication from the base station is generated at least in part based on the list of supported carrier aggregation band combinations from the UE.

13. The apparatus of claim 1 further comprising:
radio frequency circuitry coupled to the processing circuitry; and
one or more antennas coupled to the radio frequency circuitry and configured to receive the RRCConnectionReconfiguration communication from the base station.

14. A computer-readable medium comprising instructions that, when executed by one or more processors of a User Equipment (UE), cause the UE to:
decode an RRCConnectionReconfiguration communication from a base station to identify a gap offset field, the RRCConnectionReconfiguration communication comprising a measure gap configuration (MeasGapConfig) information element, the MeasGapConfig information element comprising the gap offset field (gapOffset) indicating one or more gap offset gap patterns, the one or more gap offset gap patterns (gp) comprising at least a first network-controlled small-gap (ncsg) gap pattern (gp-ncsg);
set up a measurement gap configuration indicated by the MeasGapConfig information element in accordance with the gapOffset; and
encode signaling for measurement reporting in accordance with the MeasGapConfig information element and gapOffset of the RRCConnectionReconfiguration communication.

15. The computer-readable medium of claim 14 wherein the gapOffset comprises at least three values, each value of the gapOffset associated with different gap pattern settings;
wherein the gapOffset comprises a gp2 value corresponding to an MGRP value of 40 ms and a 3 ms gap duration for measurement; and
wherein the MeasGapConfig information element comprises a serving cell identifier (ID) list associated with a corresponding PCell and SCell.

16. The computer-readable medium of claim 14 wherein the instructions further configure the UE to:
decode a UE capability enquiry from the base station;
in response to the UE capability enquiry, communicate a support-NCSG-r14 response indicating that the UE supports NCSG measurement gap operation; and
process an RRC Setup with the base station prior to receipt of the UE capability enquiry;
wherein the UE further communicates a list of supported carrier aggregation band combinations and non-carrier aggregation bands in response to the UE capability enquiry prior to processing of the RRCConnectionReconfiguration communication; and
wherein the RRCConnectionReconfiguration communication from the base station is generated at least in part based on the list of supported carrier aggregation band combinations from the UE.

17. An apparatus of a base station, the apparatus comprising:
processing circuitry configured to:
generate an RRCConnectionReconfiguration communication for a user equipment (UE), the RRCConnectionReconfiguration communication comprising a measure gap configuration (MeasGapConfig) information element, the MeasGapConfig information element comprising a gap offset field (gapOffset) indicating one or more gap offset gap patterns, the one or more gap offset gap patterns (gp) comprising at least a first network-controlled small-gap (ncsg) gap pattern (gp-ncsg);
encode the RRCConnectionReconfiguration communication for transmission to the UE from the base station; and
decode signaling for measurement reporting in accordance with the MeasGapConfig information element and gapOffset of the RRCConnectionReconfiguration communication; and
an interface coupled to the processing circuitry and configured to:
transmit the RRCConnectionReconfiguration communication; and
receive the signaling for the measurement reporting.

18. The apparatus of claim 17 wherein the gapOffset comprises a first value indicating a per-component carrier measurement configuration.

19. The apparatus of claim 18 wherein the RRCConnectionReconfiguration communication comprises a measurement gap configuration per component carrier-list (MeasGapConfigPerCC-list) information element, the MeasGapConfigPerCC-list information element comprising at least the MeasGapConfig information element.

20. A computer-readable medium comprising instructions that, when executed by one or more processors of a base station, cause the base station to:
generate an RRCConnectionReconfiguration communication for a user equipment (UE), the RRCConnectionReconfiguration communication comprising a measure gap configuration (MeasGapConfig) information element, the MeasGapConfig information element comprising a gap offset field (gapOffset) indicating one or more gap offset gap patterns, the one or more gap offset gap patterns (gp) comprising at least a first network-controlled small-gap (ncsg) gap pattern (gp-ncsg);
encode the RRCConnectionReconfiguration communication for transmission to the UE from the base station; and
decode signaling for measurement reporting in accordance with the MeasGapConfig information element and gapOffset of the RRCConnectionReconfiguration communication.

21. The computer-readable medium of claim 20 wherein the gapOffset comprises at least three values, each value of the gapOffset associated with different gap pattern settings.

22. The computer-readable medium of claim 20 wherein the MeasGapConfig information element comprises a serving cell identifier (ID) list associated with a corresponding PCell and SCell.
